(19) United States
(12) Patent Application Publication
(10) Pub. No.: US 2024/0004255 A1
(43) Pub. Date: Jan. 4, 2024

(54) Sealing Films and Sealing Compositions for Sealing Microcells of Electro-Optic Devices

(71) Applicant: E Ink Corporation, Billerica, MA (US)

(72) Inventors: Alicia ANDREWS-VAFAI, Milpitas, CA (US); Ali SARVI, San Jose, CA (US); Abraham BERHANE, Tracy, CA (US); Mary E. PARENT, Mountain View, CA (US)

(21) Appl. No.: 18/339,470

(22) Filed: Jun. 22, 2023

Related U.S. Application Data
(60) Provisional application No. 63/357,745, filed on Jul. 1, 2022.

(51) Int. Cl. G02F 1/1679; C08L 23/08

(52) U.S. Cl. CPC G02F 1/1679; C08L 23/0869; C08L 2203/162; C08L 2205/03

(57) ABSTRACT

The present invention is directed to an aqueous sealing composition that comprises a combination of polymers, a poly(vinyl alcohol) homopolymer or poly(vinyl alcohol-co-ethylene) copolymer, a polyurethane, and a rheology modifier in an aqueous carrier. The aqueous sealing composition may be used to form a low-defect sealing film in electro-optic devices having an electro-optic material layer, comprising (a) a plurality of microcells filled with charged particles and a non-polar fluid and (b) a sealing film, wherein the electro-optic material layer is disposed between two electrode layers. The corresponding electro-optic devices exhibit good electro-optic performance.

### CROSS-REFERENCE TO RELATED APPLICATIONS

This application claims priority to U.S. Provisional Patent Application No. 63/357,745, filed on Jul. 1, 2022. The entire contents of any patent, published application, or other published work referenced herein is incorporated by reference.

### FIELD OF THE INVENTION

This invention relates to a sealing film that can be used in electro-optic devices, such as electrophoretic displays. The sealing film comprises poly(vinyl alcohol) homopolymer or poly(vinyl alcohol-co-ethylene) copolymer, polyurethane, and a rheology modifier, the rheology modifier being selected from the group consisting of Hydrophobically Modified Ethoxylated Urethane and Alkali Swellable Emulsion polymer.

### BACKGROUND OF THE INVENTION

The term “electro-optic”, as applied to a material, a device or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic devices. This type of display is properly called “multi-stable” rather than bistable, although for convenience the term “bistable” may be used herein to cover both bistable and multi-stable displays.

One type of electro-optic device, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays.

Numerous patents and applications assigned to or in the names of the Massachusetts Institute of Technology (MIT), E Ink Corporation, E Ink California, LLC and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film.

The technologies described in these patents and applications include:
(a) Electrophoretic particles, fluids and fluid additives; see for example U.S. Pat. Nos. 7,002,728; and 7,679,814;
(b) Capsules, binders and encapsulation processes; see for example U.S. Pat. Nos. 6,922,276; and 7,411,719;
(c) Microcell structures, wall materials, and methods of forming microcells; see for example U.S. Pat. Nos. 7,072,095; and 9,279,906;
(d) Methods for filling and sealing microcells; see for example U.S. Pat. Nos. 7,144,942; 7,005,468; and 7,715,088; and U.S. Patent Application Publications Nos. 2004-0120024; and 2004-0219306;
(e) Films and sub-assemblies containing electro-optic materials; see for example U.S. Pat. Nos. 6,982,178; and 7,839,564;
(f) Backplanes, adhesive layers and other auxiliary layers and methods used in displays; see for example U.S. Pat. Nos. 7,116,318; and 7,535,624;
(g) Color formation and color adjustment; see for example U.S. Pat. Nos. 7,075,502; and 7,839,564;
(h) Methods for driving displays; see for example U.S. Pat. Nos. 7,012,600; and 7,453,445;
(i) Applications of displays; see for example U.S. Pat. Nos. 7,312,784; and 8,009,348; and
(j) Non-electrophoretic displays, as described in U.S. Pat. No. 6,241,921; and U.S. Patent Applications Publication No. 2015/0277160; and applications of encapsulation and microcell technology other than displays; see for example U.S. Pat. No. 7,615,325; and U.S. Patent Application Publications Nos. 2015/0005720 and 2016/0012710.

The contents of all of the above references are incorporated herein by reference in their entirety.

Structures having a plurality of sealed microcells containing a dispersion of charged pigment particles in a non-polar fluid are used commercially in electro-optic devices. The microcells are also known as microcavities or microcups in the literature. Atypical process of making sealed microcell structures for electro-optic devices involves (a) fabricating, via microembossing, a polymeric sheet having a plurality of microcavities, wherein each microcavity has an opening, (b) filling the microcavities with an electrophoretic medium, which is a dispersion comprising charged pigment particles in a non-polar fluid, and (c) sealing the microcavities with an aqueous sealing composition to form a sealing film. The sealed microcavities, which contain electrophoretic medium, form the electro-optic material layer of the device. The electro-optic material layer is disposed between a front electrode and a rear electrode. Application of an electric field across the electrophoretic medium via these electrodes causes pigment particles to migrate through the electrophoretic medium creating an image. The sealing film plays an important role for the function and performance of the device. Firstly, because the sealing film is in contact with the electrophoretic medium and seals it inside the microcavities, it must (1) be practically insoluble to the non-polar fluid of the electrophoretic medium and (2) be a good barrier to the non-polar fluid, so that the non-polar fluid does not diffuse out form the microcells during the life of the device. Inferior barrier properties of the sealing film towards the non-polar fluids lead to the reduction of the fluid in the electrophoretic medium and sagging of the sealing film. Secondly, the sealing film must not absorb significant amount of moisture from the environment; that is, it must prevent environmental moisture from entering into the electrophoretic medium of the device. Such moisture would negatively affect the electro-optic performance of the device. Thirdly, the sealing composition should be coated onto the microcell layer to form a sealing film without significant coating defects, because such defects negatively affect the electro-optic performance of the corresponding device. Fourthly, the sealing film should be mechanically resilient during the useful life of the device. Finally, the sealing film should have optimum volume resistivity that remains practically constant over time. The electrically conductive properties of the sealing film are important, because electrical potential is applied across the device and propagated via the sealing film, among other components.

The technical problem of providing aqueous sealing compositions that form sealing films with these features is difficult, because the different objectives may require different formulation strategies. For examples, barrier property for non-polar fluids typically require more hydrophilic components, whereas such components absorb more moisture from the environment. Furthermore, if the sealing film has low electrical conductivity, the operation of the device requires increased power consumption, whereas too high conductivity may cause inferior image quality because of blooming. Thus, there is a need for aqueous sealing compositions that form optimized sealing films with less defects, improved barrier towards non-polar fluids, reduced moisture absorption, and improved electro-optic performance. The inventors of the present invention found that sealing film compositions comprising combination of poly(vinyl alcohol) homopolymer or poly(vinyl alcohol-co-ethylene) copolymer, polyurethane, and a rheology modifier, the rheology modifier being a Hydrophobically Modified Ethoxylated Urethane or an Alkali Swellable Emulsion polymer provide sealing films with less defects and good electro-optic performance.

### SUMMARY OF THE INVENTION

In one aspect, the present invention is directed to a sealing film comprising from 15 to 60 weight % of a water soluble poly(vinyl alcohol) homopolymer or poly(vinyl alcohol-co-ethylene) copolymer by weight of the sealing film, from 7 to 29 weight % of polyurethane by weight of the sealing film, and from 0.05 to 10 weight % of a rheology modifier by weight of the sealing film. The poly(vinyl alcohol) homopolymer has a degree of hydrolysis of from 90% to 99.5%. The poly(vinyl alcohol-co-ethylene) copolymer has a degree of hydrolysis of from 90% to 99.5% and ethylene content of less than 10%. The rheology modifier is selected from the group consisting of Hydrophobically Modified Ethoxylated Urethane and Alkali Swellable Emulsion polymer. The sealing film may further comprise from 0.001 to 5 weight % of a surfactant by weight of the sealing film. The sealing film may comprise from 0.01 to 5 weight % of a surfactant by weight of the sealing film, or from 0.01 to 2 weight % of a surfactant by weight of the sealing film. The surfactant of the sealing film may be a fluorosurfactant. The sealing film may further comprise from 5 to 70 weight % of carbon black by weight of the sealing film. The carbon black may have oil adsorption number less than 100 mL per 100 mg of carbon black measured using OAN method according to ASTM 2414. The carbon black may have total surface area less than 70 m²/g measured using the nitrogen adsorption method according to ASTM D 6556.

The sealing film may further comprise from 4.5 to 25 weight % of a water soluble ether by weight of the sealing film, the water soluble ether having molecular weight of from 75 to 5,000 Dalton, and optionally comprising a hydroxyl group.

The total surface energy of the sealing film may be lower than 60 mN/m. The interfacial tension between the water soluble poly(vinyl alcohol) polymer or poly(vinyl alcohol-co-ethylene) copolymer and the polyurethane may be less than 2 mN/m. The sealing film may have volume resistivity of from 10⁷ to 10¹¹ Ohm·cm.

The polyurethane of the sealing film may be an ester polyurethane, a polycarbonate polyurethane, or a combination thereof. The polyurethane of the sealing film may have number average molecular weight from 1,000 to 2,000,000 Daltons.

The poly(vinyl alcohol) homopolymer or poly(vinyl alcohol-co-ethylene) copolymer of the sealing film may have number average molecular weight from 1,000 to 1,000,000 Daltons. The poly(vinyl alcohol) polymer or poly(vinyl alcohol-co-ethylene) copolymer of the sealing film may have a degree of hydrolysis of from 92% to 99%. The poly(vinyl alcohol-co-ethylene) copolymer of the sealing film may have ethylene content of less than 9%.

In another aspect, the present invention is directed to an electro-optic device comprising a conductive layer, a microcell layer, a sealing film, an adhesive layer, and an electrode layer. The microcell layer comprises a plurality of microcells, each microcell including an opening, each microcell comprising an electrophoretic medium. The electrophoretic medium comprises charged particles in a non-polar carrier. The sealing film of the electro-optic device comprises from 15 to 60 weight % of a water soluble poly(vinyl alcohol) homopolymer or poly(vinyl alcohol-co-ethylene) copolymer by weight of the sealing film, from 7 to 29 weight % of a polyurethane by weight of the sealing film, from 0.05 to 10 weight % of a rheology modifier by weight of the sealing film. The poly(vinyl alcohol) homopolymer has a degree of hydrolysis of from 90% to 99.5%. The poly(vinyl alcohol-co-ethylene) copolymer has a degree of hydrolysis of from 90% to 99.5% and ethylene content of less than 10%. The rheology modifier is selected from the group consisting of Hydrophobically Modified Ethoxylated Urethane and Alkali Swellable Emulsion polymer. The electrophoretic medium of the electro-optic device may comprise at least three types of charged pigment particles, at least one type of charged particles having a color selected from the group consisting of blue, green, red, cyan, magenta, and yellow.

In yet another, the present invention is directed to an aqueous sealing composition comprising from 15 to 60 weight % of a water soluble poly(vinyl alcohol) homopolymer or poly(vinyl alcohol-co-ethylene) copolymer by weight of the aqueous sealing composition excluding water, from 7 to 29 weight % of a polyurethane by weight of the aqueous sealing composition excluding water, from 0.05 to 5 weight % of a rheology modifier by weight of the aqueous sealing composition excluding water, from 0.01 to 5 weight % of a surfactant by weight of the aqueous sealing composition excluding water, and from 20 to 95 weight % water by weight of the aqueous sealing composition. The poly(vinyl alcohol) homopolymer has a degree of hydrolysis of from 90% to 99.5%. The poly(vinyl alcohol-co-ethylene) copolymer has a degree of hydrolysis of from 90% to 99.5% and ethylene content of less than 10%. The rheology modifier is selected from the group consisting of Hydrophobically Modified Ethoxylated Urethane and Alkali Swellable Emulsion polymer. The surfactant of the aqueous sealing composition may be a fluorosurfactant.

The aqueous sealing composition may further comprise from 5 to 70 weight % of carbon black by weight of the aqueous sealing composition excluding water. The carbon black may have oil adsorption number less than 100 mL per 100 mg of carbon black measured using OAN method according to ASTM 2414. The carbon black may have total surface area less than 70 m²/g measured using the nitrogen adsorption method according to ASTM D 6556.

The aqueous sealing composition may further comprise from 1.0 to 40 weight % of a water soluble ether by weight of the aqueous sealing composition excluding water, the water soluble ether having molecular weight of from 75 to 5,000 Dalton (grams per mole), and optionally comprising a hydroxyl group.

The aqueous sealing composition may also comprise from 0.1 to 8 weight % of a polyurethane crosslinker by weight of the aqueous sealing composition excluding water. The polyurethane crosslinker being a polyisocyanate, a multifunctional polycarbodiimide, a multifunctional aziridine, a silane coupling agent, a boron/titanium/zirconium-based crosslinker, or a melamine formaldehyde.

The Viscosity Ratio of the aqueous sealing composition at shear rate of 10⁻⁴ l/s divided by the viscosity of the aqueous sealing composition at shear rate of 10² l/s may be 7 or lower. The Viscosity Ratio of the aqueous sealing composition at shear rate of 10⁻⁴ l/s divided by the viscosity of the aqueous sealing composition at shear rate of 10² l/s may be from 1 to 7. The aqueous sealing composition may have an H-B Rate Index of 0.7 or higher. The aqueous sealing composition may have an H-B Rate Index of from 0.7 to 1, from 0.7 to 0.9, or from 0.7 to 2. The aqueous sealing composition may have a thixotropic index of 1.5 or higher. The aqueous sealing composition may have a thixotropic index of from 1.5 to 3.

### BRIEF DESCRIPTION OF DRAWINGS

FIG. 1 illustrates a structure of a plurality of microcells before they are filled and sealed (side view).

FIG. 2 illustrates an example of an electro-optic device comprising a microcell structure (side view).

FIG. 3 illustrates an example of a front plane laminate assembly that can be used to form an electro-optic device comprising a microcell structure (side view).

FIG. 4 illustrates an example of a double release sheet that can be used to form an electro-optic device comprising a microcell structure (side view).

FIG. 5 shows a method for making microcells using a roll-to-roll process.

FIGS. 6A and 6B detail the production of microcells using photolithographic exposure through a photomask of a conductor film coated with a thermoset precursor.

FIGS. 6C and 6D detail an alternate embodiment in which microcells are fabricated using photolithography. In FIGS. 6C and 6D a combination of top and bottom exposure is used, allowing the walls in one lateral direction to be cured by top photomask exposure, and the walls in another lateral direction to be cured by bottom exposure through the opaque base conductor film.

FIGS. 7A-7D illustrate the steps of filling and sealing an array of microcells.

FIG. 8 illustrates the structure of the electro-optic device that was used for the evaluation of the aqueous sealing composition examples for electro-optic performance.

FIG. 9 illustrates the structure of the electro-optic device that was used for the evaluation of the aqueous sealing composition examples for barrier properties.

FIGS. 10A-10D show microscope images of microcells evaluated for barrier properties.

FIG. 11 shows examples of sealing films that correspond to the Dewetting ranking system.

FIG. 12 shows examples of sealing films that correspond to the Delamination ranking system.

FIG. 13 shows examples of sealing films that correspond to the Chatter ranking system.

FIG. 14 shows examples of sealing films that correspond to the Cloudy Spot Mura ranking system.

FIG. 15 shows microscopic images of polymer films comprising a combination of poly(vinyl alcohol-co-ethylene) copolymer and polyurethane having different interfacial tensions.

### DETAILED DESCRIPTION OF THE INVENTION

As used herein, “molecular weight” or “MW” refers to the weight average molecular weight unless otherwise stated. Molecular weight is measured using gel permeation chromatography (“GPC”).

Degree of hydrolysis of poly(vinyl alcohol) homopolymer or poly(vinyl alcohol-co-ethylene) copolymer is the ratio of the number of moles of vinyl alcohol groups over the sum of the number of moles of the vinyl alcohol groups and the number of moles of the vinyl acetate groups in the polymer. Thus, in the example of a simplified polyvinyl alcohol formula provided below (Formula I), the degree of hydrolysis is calculated by Equation 1.

Degree of hydrolysis=100×p/(p+q) Equation 1

Manufacturers of polyvinyl alcohol typically report the degree of hydrolysis of their products, because this parameter affects important physical properties of the polymer, such as water solubility of the polymer and water resistance of the corresponding dry film. A titration method is used to determine the degree of hydrolysis of polyvinyl alcohols (homopolymers and copolymers). Details of the method are described in Method JIS K 6726 (Japanese Standard Association, 94^{th} Edition, Oct. 20, 2017).

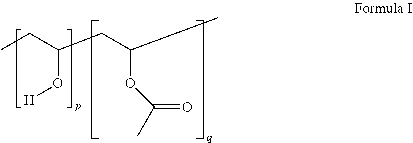

The terms “sealing film” and “sealing layer” are synonymous and are used interchangeably in relation to an electro-optic device.

The terms “adhesive film” and “adhesive layer” are synonymous and are used interchangeably in relation to an electro-optic device.

The terms “surfactant”, “surface active agent”, and “wetting agent” are synonymous herein. “Surfactant” or “surface active agent” or “wetting agent” is a substance that can lower the surface tension of a liquid, the interfacial tension between two liquids, the interfacial tension between a gas and a liquid, and the interfacial tension between a liquid and a solid. Surfactants are usually organic compounds that are amphiphilic, which means that they contain both one or more hydrophobic functional groups (tail) and one or more hydrophilic groups (head). A “fluorosurfactants” is a surfactant that has at least one fluorine atom in its molecular structure, more specifically, a fluorine atom in an alkyl chain of the surfactant tail. The fluorosurfactant may have more than one fluorine atom in an alkyl chain of the surfactant tail.

Unless otherwise stated, the disclosed contents of the components of the sealing film are calculated as weight % of the component by weight of the sealing film. Unless otherwise stated, the disclosed contents of the components of the aqueous sealing composition are calculated as weight % of the aqueous sealing composition excluding water (except, of course, for the disclosed content of the water in the aqueous composition).

A. Structure of Microcells

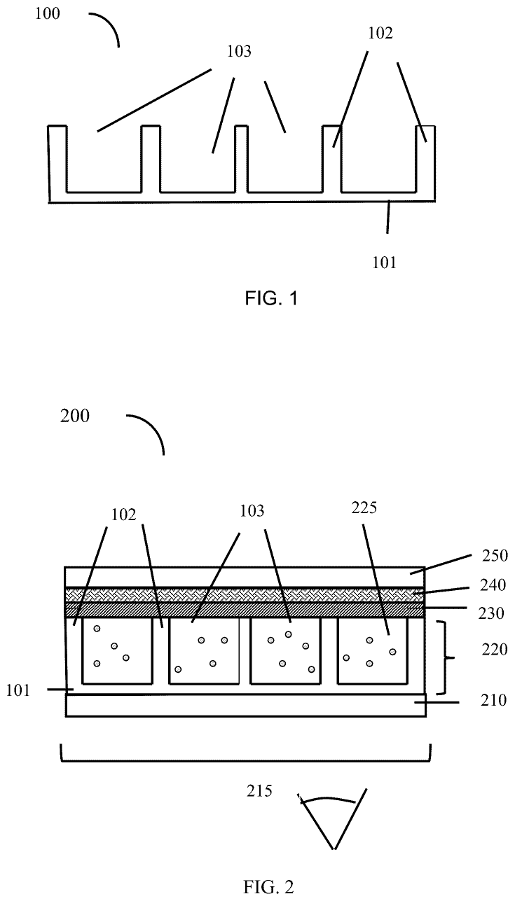

FIG. 1 illustrates a structure of a plurality of microcells 100 in side view. This illustration represents the plurality of microcells 100 before they are filled and sealed. Each microcell comprises a bottom 101, walls 102, and an opening 103.

B. Structure of Electro-Optic Devices Comprising Microcell Structures

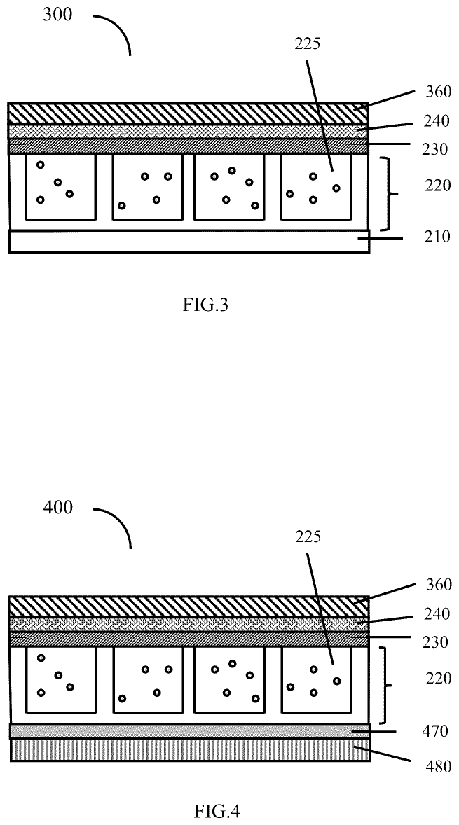

FIG. 2 illustrates an example of an electro-optic device 200 shown in side view. The electro-optic device of this example comprises a first light-transmissive electrode layer 210, a microcell layer 220, a sealing film 230, an adhesive layer 240, and a second electrode layer 250. The microcell layer comprises a plurality of microcells that are defined by bottom 101 and walls 102 of the microcells. Each microcell of the plurality of microcells has an opening 103. Each microcell of the plurality of microcells contains electrophoretic medium 225, which comprises charged particles in a non-polar fluid. The microcells are sealed with sealing film 230, which spans the openings 102 of the plurality of the microcells. A second electrode layer 250 is connected to sealing film 230 using adhesive layer 240. Each microcell of the plurality of microcells sealed with the sealing film forms the electro-optic material layer of electro-optic device 200. A source of an electric field may connect first light-transmissive electrode layer 210 with second electrode layer 250. Application of an electric field across the electrophoretic material layer causes the charged particles to migrate through the electrophoretic medium, creating an image that can be observed by an observer looking from viewing side 215 of electro-optic device 200. An optional primer layer (not shown in FIG. 2) may be disposed between first light-transmissive electrode layer 210 and microcell layer 220.

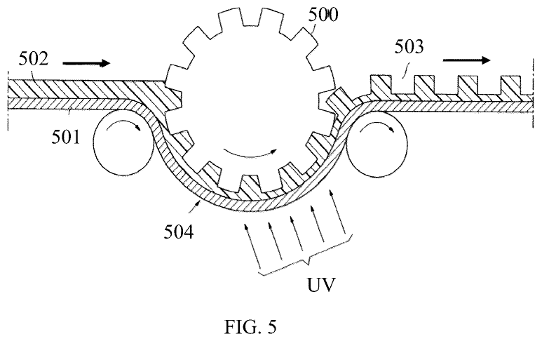

The example of an electro-optic device illustrated in FIG. 2 may be constructed by a front plane laminate 300, a side view illustration of which is shown in FIG. 3. Front plane laminate 300 comprises a first light-transmissive electrode layer 210, a microcell layer 220, a sealing film 230, an adhesive layer 240, and a release sheet 360. Each of the plurality of microcells contains electrophoretic medium 225, which comprises charged particles in a non-polar fluid. The microcells are sealed with sealing film 230, which spans the openings of the plurality of the microcells. A release sheet 360 is connected to sealing film 230 using adhesive layer 240. Removal of release sheet 360 exposes the surface of adhesive layer 240, which may be connected onto a second electrode layer to form an electro-optic device. An optional primer layer (not shown in FIG. 3) may be disposed between first light-transmissive electrode layer 210 and microcell layer 220.

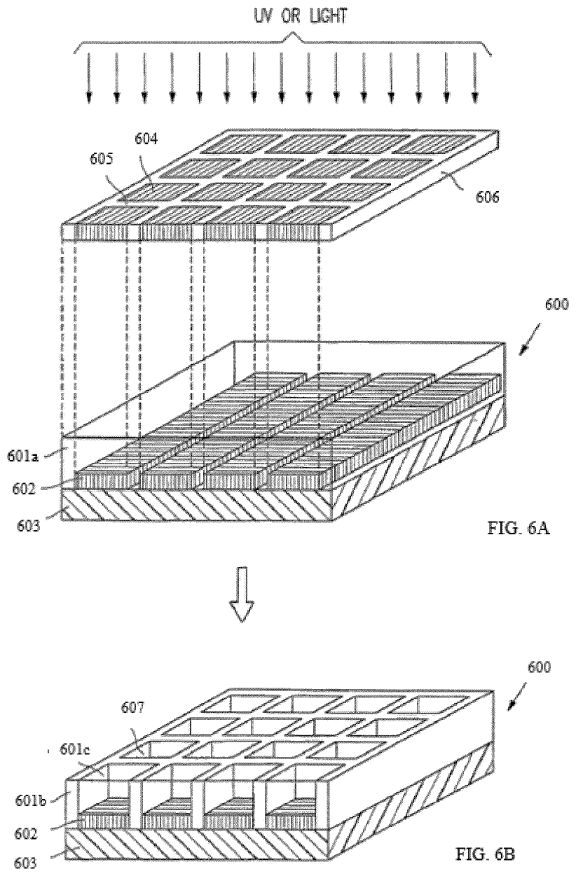

The example of an electro-optic device illustrated in FIG. 2 may also be constructed by a double release sheet 400, a side view of which is shown in FIG. 4. Double release sheet 400 comprises a first release sheet 480, a first adhesive layer 470, a microcell layer 220, a sealing film 230, a second adhesive layer 340, and a second release sheet 360. Each of the plurality of microcells contains electrophoretic medium 225, which comprises charged particles in a non-polar fluid. The microcells are sealed with sealing film 230. Sealing film 230 spans the openings of the plurality of the microcells. First release sheet 480 is connected to microcell layer 220 using first adhesive layer 470. Second release sheet 360 is connected to sealing film 230 using second adhesive layer 240. Removal of first release sheet 460 exposes the surface of first adhesive layer 470, which may be connected onto a first light-transmissive electrode layer. Removal of second release sheet 360 exposes the surface of second adhesive layer 240, which may be connected onto a second electrode layer to form an electro-optic device. An optional primer layer (not shown in FIG. 4) may be disposed between first adhesive layer 470 and microcell layer 220.

C. Formation of Microcell Structures

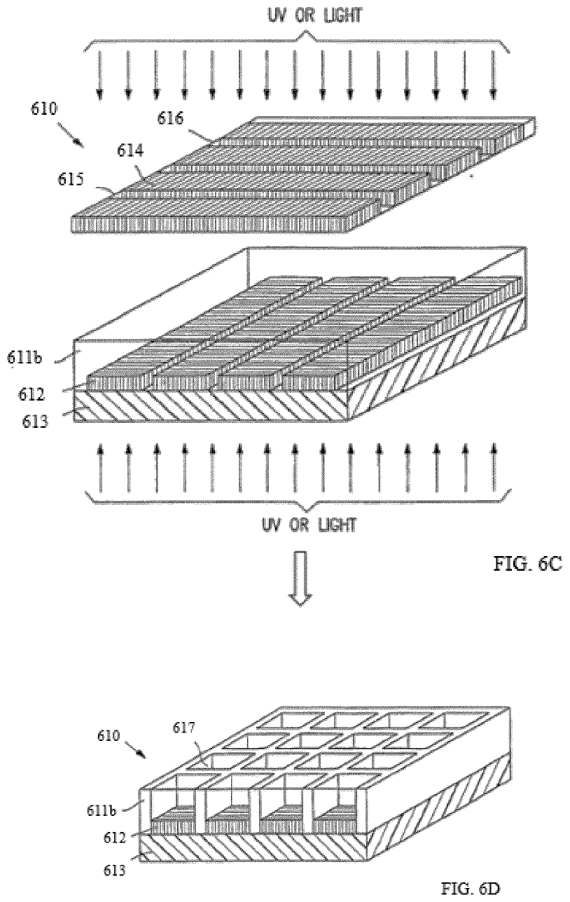

Techniques for constructing microcells. Microcells may be formed either by a batchwise process or by a continuous roll-to-roll process as disclosed in U.S. Pat. No. 6,933,098. The latter offers a continuous, low cost, high throughput manufacturing technology for production of compartments for use in a variety of applications including benefit agent delivery and electrophoretic displays. Microcell arrays suitable for use with the invention can be created with microembossing, as illustrated in FIG. 5. A male mold 500 may be placed either above a web 504 or below the web 504 (not shown); however, alternative arrangements are possible. For examples, please see U.S. Pat. No. 7,715,088, which is incorporated herein by reference in its entirety. A conductive substrate may be constructed by forming a conductor film 501 on a polymer substrate that becomes a backing layer for a device. A composition comprising a thermoplastic, thermoset, or a precursor thereof is then coated on conductor film 501. The thermoplastic or thermoset precursor layer 502 is embossed at a temperature higher than the glass transition temperature of the material of thermoplastics or thermoset precursor layer 502 by the male mold in the form of a roller, plate or belt.

Thermoplastic or thermoset precursor layer 502 for the preparation of the microcells may comprise multifunctional acrylate or methacrylate, vinyl ether, epoxide and oligomers or polymers thereof, and the like. A combination of multifunctional epoxide and multifunctional acrylate is also very useful to achieve desirable physico-mechanical properties. A crosslinkable oligomer imparting flexibility, such as urethane acrylate or polyester acrylate, may be added to improve the flexure resistance of the embossed microcells. The composition of thermoplastic or thermoset precursor layer 502 may contain a polymer, oligomer, monomer and additives or only an oligomer, monomer and additives. The glass transition temperatures (T_{g}) for this class of materials usually range from about −70° C. to about 150° C. or from about −20° C. to about 50° C. The microembossing process is typically carried out at a temperature higher than the T_{g}. A heated male mold or a heated housing substrate, against which the mold presses, may be used to control the microembossing temperature and pressure.

As shown in FIG. 5, the mold is released during or after thermoplastic or thermoset precursor layer 502 is hardened to reveal an array of microcells 503. The hardening of thermoplastic or thermoset precursor layer 502 may be accomplished by cooling, solvent evaporation, cross-linking by radiation, heat or moisture. In the case of a thermoset precursor layer, the curing may be accomplished by UV radiation. In such a case, UV may radiate onto the transparent conductor film from the bottom or the top of the web as shown in the two figures. Alternatively, UV lamps may be placed inside the mold. In this case, the mold must be transparent to allow the UV light to radiate through the pre-patterned male mold onto the thermoset precursor layer. A male mold may be prepared by any appropriate method, such as a diamond turn process or a photoresist process followed by either etching or electroplating. A master template for the male mold may be manufactured by any appropriate method, such as electroplating. With electroplating, a glass base is sputtered with a thin layer (typically 3000 Å) of a seed metal such as chrome inconel. The mold is then coated with a layer of photoresist and exposed to UV. A mask is placed between the source of the UV light and the layer of photoresist. The exposed areas of the photoresist become hardened. The unexposed areas are then removed by washing them with an appropriate solvent. The remaining hardened photoresist is dried and sputtered again with a thin layer of seed metal. The master is then ready for electroforming. A typical material used for electroforming is nickel cobalt. Alternatively, the master can be made of nickel by electroforming or electroless nickel deposition. The floor of the mold is typically between about 50 to about 400 micrometers. The master can also be made using other microengineering techniques including e-beam writing, dry etching, chemical etching, laser writing or laser interference as described in “Replication techniques for micro-optics”, SPIE Proc. Vol. 3099, pp. 76-82 (1997). Alternatively, the mold can be made by photomachining using plastics, ceramics or metals.

Prior to applying a UV curable resin composition, the mold may be treated with a mold release agent to aid in the demolding process. The UV curable resin may be degassed prior to dispensing and may optionally contain a solvent. The solvent, if present, readily evaporates. The UV curable resin is dispensed by any appropriate means, such as coating, dipping, pouring or the like, over the male mold. The dispenser may be moving or stationary. A conductor film is overlaid the UV curable resin. If necessary, pressure may be applied to ensure proper bonding between the resin and the plastic and to control the thickness of the bottom (floor) of the microcells. The pressure may be applied using a laminating roller, vacuum molding, press device or any other like means. If the male mold is metallic and opaque, the plastic substrate is typically transparent to the actinic radiation used to cure the resin. Conversely, the male mold can be transparent and the plastic substrate can be opaque to the actinic radiation. To obtain good transfer of the molded features onto the transfer sheet, the conductor film needs to have good adhesion to the UV curable resin, which should have a good release property against the mold surface.

Microcell arrays for the invention typically include a conductive layer formed by a pre-formed conductor film, such as indium tin oxide (ITO) conductor lines; however, other conductive materials, such as silver or aluminum, may be used. The conductive layer may be backed by, or integrated into, substrates such as polyethylene terephthalate, polyethylene naphthalate, polyaramid, polyimide, polycycloolefin, polysulfone, epoxy and their composites. The conductor film may be coated with a radiation curable polymer precursor layer. The film and precursor layer are then exposed imagewise to radiation to form the microcell wall structure. Following exposure, the precursor material is removed from the unexposed areas, leaving the cured microcell walls bonded to the conductor film/support web. The imagewise exposure may be accomplished by UV or other forms of radiation through a photomask to produce an image or predetermined pattern of exposure of the radiation curable material coated on the conductor film. Although it is generally not required, the mask may be positioned and aligned with respect to the conductor film, i.e., ITO lines, so that the transparent mask portions align with the spaces between ITO lines, and the opaque mask portions align with the ITO material (intended for microcell cell floor areas).

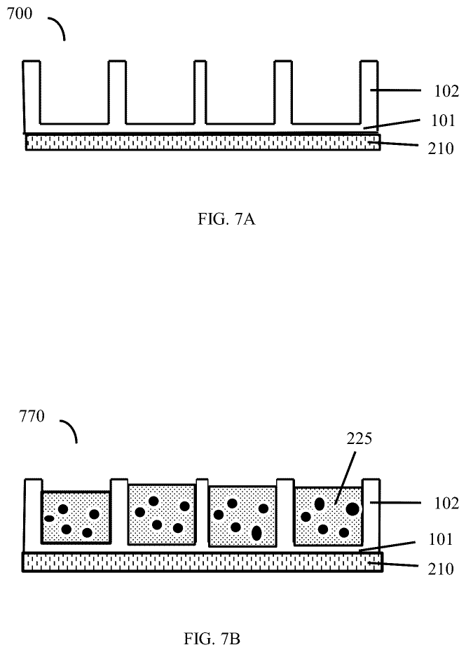

Photolithography. Microcells can also be produced using photolithography. Photolithographic processes for fabricating a microcell array are illustrated in FIGS. 6A and 5B. As shown in FIGS. 6A and 6B, a microcell array 600 may be prepared by exposure of a radiation curable material 601a coated by known methods onto a conductor electrode film 602 to UV light (or alternatively other forms of radiation, electron beams and the like) through a mask 606 to form walls 601b corresponding to the image projected through mask 606. The base conductor film 602 is preferably mounted on a supportive substrate base web 603, which may comprise a plastic material.

In the photomask 606 in FIG. 6A, the dark squares 604 represent the opaque area and the space between the dark squares represents the transparent area 605 of the mask 606. The UV radiates through the transparent area 605 onto the radiation curable material 601a. The exposure is preferably performed directly onto the radiation curable material 601a, i.e., the UV does not pass through supportive substrate base web 603 or base conductor film 602 (top exposure). For this reason, neither supportive substrate base web 603, nor the conductor 602, needs to be transparent to the UV or other radiation wavelengths employed.

As shown in FIG. 6B, the exposed areas become hardened and the unexposed areas (protected by the opaque area 604 of the mask 606) are then removed by an appropriate solvent or developer to form the microcells 607. The solvent or developer is selected from those commonly used for dissolving or reducing the viscosity of radiation curable materials such as methylethylketone (MEK), toluene, acetone, isopropanol or the like. The preparation of the microcells may be similarly accomplished by placing a photomask underneath the conductor film/supportive substrate base web and, in this case, the UV light radiates through the photomask from the bottom and the supportive substrate base web 603 needs to be transparent to radiation.

Imagewise Exposure. Still another alternative method for the preparation of the microcell array of the invention by imagewise exposure is illustrated in FIGS. 6C and 6D. When opaque conductor lines are used, the conductor lines can be used as the photomask for the exposure from the bottom. Durable microcell walls are formed by additional exposure from the top through a second photomask having opaque lines perpendicular to the conductor lines. FIG. 6C illustrates the use of both the top and bottom exposure principles to produce the microcell array 610 of the invention. The base conductor film 612 is opaque and line-patterned. The radiation curable material 611a, which is coated on the base conductor film 612 and substrate 613, is exposed from the bottom through base conductor film 612, which serves as the first photomask. A second exposure is performed from the “top” side through the second photomask 616 having a line pattern perpendicular to base conductor film 612. The spaces 615 between the lines 614 are substantially transparent to the UV light. In this process, the wall material 611b is cured from the bottom up in one lateral orientation, and cured from the top down in the perpendicular direction, joining to form an integral microcell 617. As shown in FIG. 6D, the unexposed area is then removed by a solvent or developer as described above to reveal the microcells 617.

The microcells may be constructed from thermoplastic elastomers, which have good compatibility with the microcells and do not interact with the media. Examples of useful thermoplastic elastomers include ABA, and (AB)n type of di-block, tri-block, and multi-block copolymers wherein A is styrene, α-methylstyrene, ethylene, propylene or norbornene; B is butadiene, isoprene, ethylene, propylene, butylene, dimethylsiloxane or propylene sulfide; and A and B cannot be the same in the formula. The number, n, is ≥1, preferably 1-10. Particularly useful are di-block or tri-block copolymers of styrene or α-methylstyrene such as SB (poly(styrene-b-butadiene)), SBS (poly(styrene-b-butadiene-b-styrene)), SIS (poly(styrene-b-isoprene-b-styrene)), SEBS (poly(styrene-b-ethylene/butylenes-b-styrene)) poly(styrene-b-dimethylsiloxane-b-styrene), poly((α-methylstyrene-b-isoprene), poly(α-methylstyrene-b-isoprene-b-α-methylstyrene), poly(α-methylstyrene-b-propylene sulfide-b-α-methylstyrene), poly(α-methylstyrene-b-dimethylsiloxane-b-α-methylstyrene). Commercially available styrene block copolymers such as Kraton D and G series (from Kraton Polymer, Houston, Tex.) are particularly useful. Crystalline rubbers such as poly(ethylene-co-propylene-co-5-methylene-2-norbomene) or EPDM (ethylene-propylene-diene terpolymer) rubbers such as Vistalon 6505 (from Exxon Mobil, Houston, Tex.) and their grafted copolymers have also been found very useful

The thermoplastic elastomers may be dissolved in a solvent or solvent mixture, which is immiscible with the carrier in the microcells and exhibits a specific gravity less than that of the carrier. Low surface tension solvents are preferred for the overcoating composition, because of their better wetting properties over the microcell walls and the fluid. Solvents or solvent mixtures having a surface tension lower than 35 dyne/cm are preferred. A surface tension of lower than 30 dyne/cm is more preferred. Suitable solvents include alkanes (preferably C₆₋₁₂ alkanes such as heptane, octane or Isopar solvents from Exxon Chemical Company, nonane, decane and their isomers), cycloalkanes (preferably C₆₋₁₂ cycloalkanes such as cyclohexane and decalin and the like), alkylbezenes (preferably mono- or di-C₁₋₆ alkyl benzenes such as toluene, xylene and the like), alkyl esters (preferably C₂₋₅ alkyl esters such as ethyl acetate, isobutyl acetate and the like) and C₃₋₅ alkyl alcohols (such as isopropanol and the like and their isomers) Mixtures of alkylbenzene and alkane are particularly useful.

In addition to polymer additives, the polymer mixtures may also include wetting agents (surfactants). Wetting agents, such as the FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn., may also be included in the composition to improve the adhesion of the sealant to the microcells and provide a more flexible coating process. Other ingredients including crosslinking agents (e.g., bisazides such as 4,4′-diazidodiphenylmethane and 2,6-di-(4′-azidobenzal)-4-methylcyclohexanone), vulcanizers (e.g., 2-benzothiazolyl disulfide and tetramethylthiuram disulfide), multifunctional monomers or oligomers (e.g., hexanediol, diacrylates, trimethylolpropane, triacrylate, divinylbenzene, diallylphthalene), thermal initiators (e.g., dilauroryl peroxide, benzoyl peroxide) and photoinitiators (e.g., isopropyl thioxanthone (ITX), Irgacure 651 and Irgacure 369 from Ciba-Geigy) are also highly useful to enhance the physico-mechanical properties of the sealing film by crosslinking or polymerization reactions during or after the overcoating process.

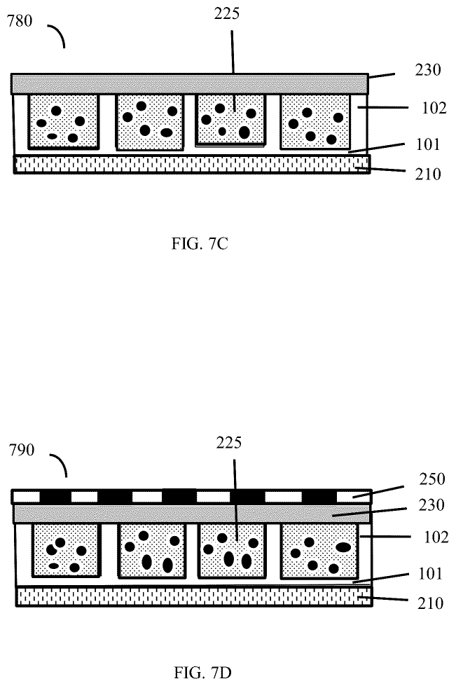

A microcell array 700 may be prepared by any of the methods described above. As shown in cross-section in FIGS. 7A-7D, the microcell walls 102 extend upward from a backing layer 101 and a conducive layer 210 (first light-transmissive electrode layer 210) to form open microcells In an embodiment, first light-transmissive electrode layer 210 is formed on or at backing layer 101. While FIGS. 7A-7D show that first light-transmissive electrode layer 210 is continuous and running above the backing layer 101, it is also possible that first light-transmissive electrode layer 210 is continuous and running below or within the backing layer 101 or it is interrupted by the microcell walls 102. Prior to filling, microcell array 700 may be cleaned and sterilized to assure that the benefit agents are not compromised prior to use.

The microcells are next filled with an electrophoretic medium 225, which comprises charged particles in a non-polar fluid to form a plurality of filled microcells 770. The microcells may be filled using a variety of techniques. In some embodiments, blade coating may be used to till the microcells to the depth of the microcell walls 102. In other embodiments, inkjet-type microinjection can be used to fill the microcells. In yet other embodiments, microneedle arrays may be used to fill an array of microcells with the electrophoretic medium 225

As shown in FIG. 7C, after filling, the microcells are sealed by applying an aqueous sealing composition to form sealed microcells 780, comprising a sealing film 230. In some embodiments, the sealing process may involve exposure to heat, dry hot air, or UV radiation. The sealing film must have good barrier properties for the non-polar fluid of the electrophoretic medium 225

In alternate embodiments, a variety of individual microcells may be filled with the desired mixture by using iterative photolithography. The process typically includes coating an array of empty microcells with a layer of positively working photoresist, selectively opening a certain number of the microcells by image-wise exposing the positive photoresist, followed by developing the photoresist, filling the opened microcells with the desired mixture, and sealing the filled microcells by a sealing process. These steps may be repeated to create sealed microcells filled with other mixtures. This procedure allows for the formation of large sheets of microcells having the desired ratio of mixtures or concentrations.

The sealing of the filled microcells may be accomplished in a number of ways. One approach involves the mixing of the aqueous sealing composition with the electrophoretic medium composition. The aqueous sealing composition may be immiscible with the electrophoretic composition, preferably having a specific gravity lower than that of the electrophoretic medium composition. The two compositions, the sealing compositing and the electrophoretic medium composition, are thoroughly mixed and immediately coated onto the plurality of microcells with a precision coating mechanism such as Mayer bar, gravure, doctor blade, slot coating or slit coating. Excess fluid is scraped away by a wiper blade or a similar device. A small amount of a weak solvent or solvent mixture such as isopropanol, methanol or an aqueous solution thereof may be used to clean the residual fluid on the top surface of the partition walls of the microcells. The aqueous sealing composition is subsequently separated from the electrophoretic medium composition and floats on top of the electrophoretic medium liquid composition. Alternatively, after the mixture of the electrophoretic medium composition and the aqueous sealing composition is filled into the microcells, a substrate may be laminated on top to control the metering of the mixture of compositions and to facilitate the phase separation of the aqueous sealing composition from the electrophoretic medium composition to form a uniform sealing film. The substrate used can be a functional substrate in the final structure or can be a sacrifice substrate, for example, a release substrate, which can be removed afterwards. A sealing film is then formed by hardening the aqueous sealing composition in situ (i.e., when in contact with the electrophoretic medium composition). The hardening of the aqueous sealing composition may be accomplished by UV or other forms of radiation such as visible light, IR or electron beam. Alternatively, heat or moisture may also be employed to harden the aqueous sealing composition if a heat or moisture curable aqueous sealing composition is used.

In a second approach, the electrophoretic medium composition may be filled into the microcells first and an aqueous sealing composition is subsequently overcoated onto the filled microcells. The overcoating may be accomplished by a conventional coating and printing process, such as blanket coating, inkjet printing or other printing processes. A sealing film, in this approach, is formed in situ, by hardening the aqueous sealing composition by solvent evaporation, radiation, heat, moisture, or an interfacial reaction. Interfacial polymerization followed by UV curing is beneficial to the sealing process. Intermixing between the electrophoretic medium composition and the sealing overcoat is significantly suppressed by the formation of a thin barrier layer at the interface by interfacial polymerization. The sealing is then completed by a post curing step, for example, by UV radiation. The degree of intermixing may be further reduced by using an aqueous sealing composition that has lower specific gravity than that of the electrophoretic medium composition. Volatile organic solvents may be used to adjust the viscosity and thickness of the sealing overcoat. Rheology of the aqueous sealing composition may be adjusted for optimal sealability and coatability. When a volatile solvent is used in the overcoat, it is preferred that it is immiscible with the solvent in the electrophoretic medium composition.

After the microcells are filled and sealed, the sealed array may be laminated with a second electrode layer 250 comprising a plurality of electrodes. Second electrode layer 250 is attached onto sealing film 230 to form the electro-optic device 790 as shown in FIG. 7D. An adhesive may be used to attach second electrode layer 250 onto the sealing film 230 (the adhesive layer is not shown in FIG. 7D). The adhesive may be electrically conductive. The adhesive of the adhesive layer, which may be a pressure sensitive adhesive, a hot melt adhesive, or a heat, moisture, or radiation curable adhesive. The laminate adhesive may be post-cured by radiation such as UV through the top conducting layer if the latter is transparent to the radiation. In other embodiments, the plurality of electrodes may be bonded directly to the sealed array of the microcell.

In general, the microcells can be of any shape, and their sizes and shapes may vary. The microcells may be of uniform size and shape in one system. However, it is possible to have microcells of mixed shapes and sizes. The openings of the microcells may be round, square, rectangular, hexagonal or any other shape. The size of the partition area between the openings may also vary. The dimension of each individual microcell may be in the range of about 1×10¹ to about 1×10⁶ m², from about 1×10² to about 1×10⁶ m², or from about 1×10³ to about 1×10⁵ μm².

The depth of the microcells may be from about 5 to about 200 μm, or from about 10 to about 100 μm. The ratio of the area of the microcell openings to the total area of the microcell layer is from about 0.05 to about 0.95, preferably from about 0.4 to about 0.9. The total area of the microcell layer is the total area of the side of the microcell layer at the same side as the microcell openings.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electro-optic material layer comprises an electrode, the layer on the opposed side of the electro-optic material layer typically being a protective layer intended to prevent the movable electrode damaging the electro-optic material layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating on a plastic film. Separately, a backplane, containing an array of pixel electrodes and an appropriate arrangement of conductors to connect the pixel electrodes to drive circuitry, is prepared. To form the final display, the substrate having the electro-optic material layer is laminated to the backplane using a lamination adhesive.

The aforementioned U.S. Pat. No. 6,982,178 describes a method of assembling a solid electro-optic device, which is well adapted for mass production. Essentially, this patent describes a so-called “front plane laminate” (“FPL”) which comprises, in order, a light-transmissive electrode layer; an electro-optic material layer in electrical contact with light-transmissive electrode layer; an adhesive layer; and a release sheet. An example of this structure is provided in FIG. 3. In FIG. 3, the electrophoretic material layer comprises the microcell layer and the sealing film. Typically, the light-transmissive electrode layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electrophoretic medium, which will normally be viewed through the light-transmissive electrode layer and adjacent substrate (if present); in cases where the electrophoretic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The light-transmissive electrode layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trade Mark) from E.I. du Pont de Nemours & Company, Wilmington DE, and such commercial materials may be used with good results in the front plane laminate. Assembly of an electrophoretic display using such a front plane laminate may be effected by removing the release sheet from the front plane laminate and contacting the adhesive layer with the backplane under conditions effective to cause the adhesive layer to adhere to the backplane, thereby securing the adhesive layer, electro-optic material layer, and light-transmissive electrode layer to the backplane. This process is well adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises an electro-optic material layer sandwiched between two adhesive layers, one or both of the adhesive layers being covered by a release sheet. FIG. 4 shows an example of a double release sheet of this form. In FIG. 4, the electrophoretic material layer comprises the microcell layer and the sealing film. Another form of the double release sheet comprises a layer of a solid electro-optic material sandwiched between two release sheets. Both forms of the double release film are intended for use in a process generally similar to the process for assembling an electrophoretic display from a front plane laminate already described, but involving two separate laminations; typically, in a first lamination the double release sheet is laminated to a front electrode layer (first light-transmissive electrode layer) to form a front sub-assembly, and then in a second lamination the front sub-assembly is laminated to a backplane to form the final display, although the order of these two laminations could be reversed if desired. The backplane comprises a second electrode layer.

U.S. Pat. No. 7,839,564 describes a so-called “inverted front plane laminate”, which is a variant of the front plane laminate described in the aforementioned U.S. Pat. No. 6,982,178. This inverted front plane laminate may comprise, in order, at least one of a light-transmissive protective layer and a light-transmissive electrode layer; an adhesive layer; an electro-optic material layer; and a release sheet. This inverted front plane laminate is used to form an electro-optic device having a layer of lamination adhesive between the electro-optic material layer and the light-transmissive electrode layer; a second, typically thin layer of adhesive may or may not be present between the electro-optic material layer and a backplane. Such electro-optic devices can combine good resolution with good low temperature performance.

Electrophoretic Medium

The electrophoretic medium, in the context of the present invention, refers to the composition in the microcells. For display applications, the microcells may be filled with at least one type of charged pigment particles in a non-polar fluid. The electrophoretic medium may comprise one type of charged type of particles or more than one type of particles having different colors, charges and charge polarities. The charged particles move through the electrophoretic medium under the influence of an electric field applied across the electro-optic material layer. The charged particles may be inorganic or organic pigments having polymeric surface treatments to improve their stability. The electrophoretic medium may comprise pigments having white, black, cyan, magenta, yellow, blue, green red, and other colors. The electrophoretic medium may also comprise, charge control agents charge adjuvants, rheology modifies, and other additives. Examples of non-polar fluids include hydrocarbons such as Isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-coming (DC-200).

The electrophoretic medium may contain two types of charged particles having different colors, a first type of charged particles having a first charge polarity, and a second type of charged particles that has a second charged polarity opposite to the first charged polarity. The first type of charged particles may be black and the second type of charged particles may be white.

The electrophoretic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. The first type of charged particles may be black, the second type of charged particles may be white, and the third type of charged particles may be selected from the group consisting of red, yellow, blue, cyan, magenta, green, and orange.

The electrophoretic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may have be higher than the charge of the fourth type of particles. In one example, the first type of charged particles is cyan, the second type of charged particles is magenta, the third type of particles is yellow and the fourth type of charged particles is white.

The electrophoretic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. In one example, the first type of particles is cyan, the second type of particles is magenta, the third type of particles is yellow, and the fourth type of particles is white.

The electrophoretic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. In one example, the first type of particles is cyan, the second type of particles is magenta, the third type of particles is black, the fourth type of particles is yellow, and the fifth type of particles is white.

Sealing Film from an Aqueous Sealing Composition

The sealing film plays an important role for the performance of a microcell electro-optic device. The sealing film may be formed by coating a sealing composition on the microcell layer of an electro-optic device. Because the sealing film is in contact with the electrophoretic medium and seals the electrophoretic medium inside the microcells, it must be practically insoluble to the non-polar fluid of the electrophoretic medium and it must be a good barrier to the non-polar fluid, so that the non-polar fluid does not diffuse out from the microcells during the life of the device. Inferior barrier properties of the sealing film towards the non-polar fluid of the electrophoretic medium lead to the reduction of the fluid from the electrophoretic medium and the sagging of the sealing film. Furthermore, the sealing film must not absorb significant amount of moisture from the environment. That is, it must prevent environmental moisture from entering into the electrophoretic medium of the device. Such moisture would affect the conductivity of the sealing film and the electrophoretic medium, negatively affecting the electro-optic performance of the device. The sealing film, which seals the microcell layer, must not have significant coating defects. Such defects negatively affect the electro-optic performance of the device. The sealing film must be mechanically resilient during the useful life of the device. It should also have optimum volume resistivity that is practically constant over time.

Another important property of the sealing film is its electrical volume resistivity. If the resistivity of the sealing film is too high, a substantial voltage drop will occur within the sealing film, requiring an increase in voltage across the electrodes to operate the device. Increasing the voltage across the electrodes in this manner is undesirable, since it increases the power consumption of the display and may require the use of more complex and expensive control circuitry to handle the increased voltage. On the other hand, if the volume resistivity of the sealing film is too low, an undesirable cross talk between adjacent pixel electrodes is observed, reducing the image quality. In addition, because the volume resistivity typically increases rapidly with decreasing temperature, too high volume resistivity of the sealing film negatively affects the low temperature electro-optic performance of the display. The sealing film may have volume resistivity of 10⁸ Ohm·cm or higher. The sealing film may have volume resistivity of from 1.0×10⁷ to 1.0×10¹² Ohm·cm, from 1.0×10⁷ to 1.0×10¹¹ Ohm·cm, from 1.0×10⁸ to 1.0×10¹¹, from 3.5×10⁷ to ×10¹² Ohm·cm, or from 1.0×10⁸ to 1.0×10¹⁰ Ohm·cm. The sealing film may have volume resistivity of 10¹¹ Ohm·cm or less, or 10¹⁰ Ohm·cm or less.

The sealing film can be prepared from an aqueous sealing composition. The aqueous sealing composition comprises from 15 to 60 weight % of a water soluble poly(vinyl alcohol) homopolymer or poly(vinyl alcohol-co-ethylene) copolymer by weight of the aqueous sealing composition excluding water, from 7 to 29 weight % of a polyurethane by weight of the aqueous sealing composition excluding water, from 0.05 to 10 weight % of a rheology modifier by weight of the aqueous sealing composition excluding water. The rheology modifier may be a Hydrophobically Modified Ethoxylated Urethane or an Alkali Swellable Emulsion polymer, or a combination thereof.

The content of rheology modifier in the aqueous sealing composition may be from 0.05 to 10 weight %, from 0.05 to 3 weight %, from 0.05 to 2 weight %, from 0.07 to 1 weight %, or from 0.08 to 1 weight % by weight of the aqueous sealing composition excluding water. The rheology modifier increases the stability of the aqueous sealing composition during its storage. It also facilitates film formation, improve sealing stability, and reduces the defects of the sealing film. Examples include associative thickeners, Alkali Swellable Acrylic emulsion polymer, and other polymeric thickeners. The aqueous sealing composition may be shear thinning, that is to say, its viscosity is reduced at higher shear rate. For example, the rheology profile of the aqueous sealing composition may shows a reduction of the viscosity between viscosity at shear rate of 10⁻⁴ l/s and the viscosity at shear rate of 10² l/s by 5 times to 10,000 times.

Hydrophobically Modified Ethoxylated Urethanes (or HEUR) are rheology modifiers that may comprise a polyethylene glycol block covalently linked by urethane. They belong to the family of“associative thickeners”. Associative thickeners have both a hydrophilic and hydrophobic regions. An example of a HEUR rheology modifier is a block of polyethylene oxide linked by a urethane and modified with a nonyl phenol hydrophobic group. The polyethylene oxide blocks of a HEUR rheology modifier have relatively low molecular weight, for example, below 12,000 Daltons (grams per mole), typically from 50-700 Daltons. HEUR rheology modifiers are non-ionic polymers that are typically soluble in water at any pH. The water solubility of HEUR rheology modifiers is a result of the presence of ethylene oxide groups in their molecular structure. HEUR may be branched or unbranched polymers. They may have terminal long-chain alkyl or alkylene groups having 8 to 30 carbon atoms. Typical alkyl groups are, for example, dodecyl or stearyl groups; a typical alkenyl group is, for example, an oleyl group; a typical aryl group is the phenyl group; and a typical alkylated aryl group is, for example, a nonylphenyl group. Some HEUR mole also contain one or more internal hydrophobic blocks or groups.

Non-limiting examples of HEUR rheology modifiers include, ACULYN™ 44, ACULYN™ 46, ACUSOL™ 880, ACUSOL™ 882, ACRYSOL™ RM-3000, ACRYSOL™ RM-895, ACRYSOL™ RM-8W, ACRYSOL™ RM-12W, ACRYSOL™ RM-995, ACRYSOL™ SCT-275, ACRYSOL™ RM-845, ACRYSOL™ RM-825, ACRYSOL™ RM-6000, ACRYSOL™ RM-5000, ACRYSOL™ RM 2020E, ACRYSOL™ RM-8W, ACRYSOL™ RM-725 supplied by Dow Chemical, RHEOVIS® PU 1190, RHEOVIS® PU 1191, RHEOVIS® PU 1291, RHEOVIS® PU 1241 and RHEOVIS® PU 1331 supplied by BASF, RHEOLATE® 212, RHEOLATE® 255, RHEOLATE® 655, RHEOLATE® 278, RHEOLATE® 678, RHEOLATE® 288, RHEOLATE® 299 and RHEOLATE® 475 supplied by Elementis Specialties, OPTIFLO® T 1000, OPTIFLO® L 1400, OPTIFLO® M 2600 VF, OPTIFLO® H 7500 VF, OPTIFLO® 3300 supplied by BYK, TEGO ViscoPlus® range supplied by TEGO, and TAFIGEL® PUR 61, TAFIGEL® PUR 50, and TAFIGEL® PUR 85 supplied by Munzing.

Alkali Swellable Emulsion (ASE) rheology modifiers are polymers that are produced using emulsion polymerization. As opposed to HEUR rheology modifiers, ASE rheology modifiers are not associative thickeners. They can be formed from hydrophilic monomers, such as (meth)acrylic acid monomers, and less hydrophilic monomers, such as (meth)acrylate ester monomers of lower alcohols (C₁ to C₄ aliphatic alcohols, such as, for example, ethyl acrylate, propyl acrylate. butyl acrylate, and methyl methacrylate). ASE rheology modifiers can provide thickening to aqueous composition at high pH. At high pH values, the (meth)acrylic acid group is water soluble in water, whereas the (meth)acrylate ester is water insoluble. At low pH values, the polymer is insoluble in water and does not thicken the aqueous composition. At high pH, the acid is neutralized towards its salt and the polymer swells, resulting in a thicker composition. Typically, ASE rheology modifiers have relatively high weight average molecular weight, that is higher than 300,000 Daltons (grams per mole), higher than 400,000 Daltons, or higher than 500,000 Daltons. Examples of hydrophilic groups include acrylic acid, methacrylic acid, and maleic acid. Examples of hydrophobic groups include esters of acrylic esters and methacrylic esters of aliphatic alcohols. Non-limiting examples of ASE rheology modifiers include RHEOVIS® 1125, RHEOVIS® 1130 supplied by BASF, ACULYN™ 33, ACULYN™ 38, ACUSOL™ 810A, ACUSOL™ 830, ACUSOL™ 835, ACUSOL™ 842, and ACRYSOL™ RM-38 (supplied by Dow Chemical), and Carbopol® Aqua 30 (supplied by Lubrizol Corporation).

Hydrophobically Modified Alkali Swellable Emulsion polymer (HASE) rheology modifiers are non-preferred rheology modifiers for the aqueous sealing compositions of the present invention. These rheology modifiers swell and thicken aqueous compositions at high pH values. They include a monomer with highly hydrophobic nature. For example, ASE polymers may be formed by monomers such as (meth)acrylic acid monomer and (meth)acrylate of a C₁-C₄ alcohol, HASE polymers may be formed by monomers such as (meth)acrylic acid monomer and (meth)acrylate of a C₈-C₂₂ alcohol.

Non-limiting examples of HASE rheology modifiers include RHEOVIS® PU 1212, 1125, RHEOVIS® 1130 supplied by BASF, ACULYN™ Excel, ACRYSOL™ TT615, ACULYN™ 22, ACULYN™ 88, ACUSOL™ 801S, ACUSOL™ 805S, ACUSOL™ 820 and ACUSOL™ 823 supplied by Dow Chemical.

The aqueous sealing composition may further comprise a conductive filler. The content of the conductive filler in the aqueous sealing composition may be from 5 to 70 weight % by weight of the aqueous sealing composition excluding water. The filler of the aqueous sealing composition may be selected from the group consisting of carbon black, graphene, graphite, and carbon nanotubes. The filler decreases the volume resistivity of the sealing film, but it may also affect other properties of the layer such as its surface energy. In order to be effective as a filler, carbon black must have good dispersibility in the aqueous sealing composition. The content of conductive carbon black in the aqueous sealing composition may be from 10 to 60 weight %, from 15 to 50 weight %, from 20 to 45 weight %, or from 30 to 40 weight % of the aqueous sealing composition.

The oil adsorption value of the carbon black used in the aqueous sealing composition may be 100 cm³ or less per 100 mg of carbon black. The value of oil adsorption is typically reported by carbon black manufacturers as OAN (Oil Absorption Number), measured using the method according to ASTM 2414. It represents the degree of structure and aggregation of the carbon black particles. That is, the larger the OAN, the higher the structure of the carbon black particles (connected with each other and having branched structures) and/or the higher the degree of aggregation of the particles. More structured/aggregated carbon black may generally provide higher conductivity to the sealing film, although conductivity may also depend on the dispersibility of the filler, with higher OAN indicating that it may be more difficult to disperse the carbon black. The carbon black filler of the aqueous sealing composition may have preferably average diameter of primary particles larger than 30 nm. This is another physical property of carbon black grades that may be reported by carbon black manufacturers. Primary particles may be determined by electron microscopy. Typically, carbon black having very small average diameter of primary particles are difficult to disperse. The carbon black may have total surface area less than 80 m²/g, less than 75 m²/g, or less than 70 m²/g. This is another common physical property that is routinely reported by carbon black manufacturers. It is measured using the nitrogen adsorption method according to ASTM D 6556. The carbon black may have volume resistivity higher than 0.1 Ohm·cm, measured in the powder form at pressure of 40 MPa using method ASTM D 2663.

The total surface energy of the conductive carbon black of the aqueous sealing composition may be higher than 40 mN/m, or higher than 55 mN/m, determined with the Washburn method, using hexane as test liquid. The total surface energy of the conductive carbon black of the aqueous sealing composition may be from 40 mN/m to 80 mN/m, from 40 mN/m to 70 mN/m, or from 40 mN/m to 65 mN/m. The dispersive component of the surface energy of the conductive carbon black may be higher than 15 mN/m, determined with the Washburn method using hexane as test liquid. The dispersive component of the conductive filler may be from 15 mN/m to 40 mN/m, or from 15 mN/m to 30 mN/m.

The content of the water soluble poly(vinyl alcohol) homopolymer or poly(vinyl alcohol-co-ethylene) copolymer in the aqueous sealing composition may be from 15 to 60 weight %, from 18 to 55 weight %, from 20 to 50 weight %, or from 22 to 40 weight % by weight of the aqueous sealing composition excluding water.

The poly(vinyl alcohol) homopolymer has a degree of hydrolysis of from 90% to 99.5%, and the poly(vinyl alcohol-co-ethylene) copolymer has a degree of hydrolysis of from 90% to 99.5% and ethylene content of less than 10%. The degree of hydrolysis of the poly(vinyl alcohol) homopolymer and the poly(vinyl alcohol-co-ethylene) copolymer may be from 92% to 99%, or from 92% to 95%. The ethylene content of the poly(vinyl alcohol-co-ethylene) copolymer may be less than 9%, less than 8.5%, or less than 8%. The degree of hydrolysis of homopolymers and copolymers of polyvinyl alcohols is routinely reported by manufactures of such polymer and it indicates the proportion by units (moles) of vinyl alcohol in the polymer to the total vinyl units. The other units are typically vinyl acetate (ester). The ethylene content of poly(vinyl alcohol-co-ethylene) copolymers is also reported by the manufacturers and represent the proportion of units (moles) of ethylene in the polymer to the other units. In this case, the other unit is vinyl alcohol and vinyl acetate. The poly(vinyl alcohol) homopolymer and the poly(vinyl alcohol-co-ethylene) copolymer of the aqueous sealing composition may have weight average molecular weight (MW) of from 1,000 to 1,000,000 Daltons (grams per mole), from 10,000 to 500,000 Daltons, or from 20,000 to 400,000 Daltons.

Polyurethanes are typically prepared via a polyadditional process involving a diisocyanate. Non-limiting examples of polyurethanes include polyether polyurethanes, polyester polyurethanes, polycarbonate polyurethanes, polyether polyureas, polyureas, polyester polyureas, polyester polyureas, polyisocyanates (e.g., polyurethanes comprising isocyanate bonds), and polycarbodiimides (e.g., polyurethanes comprising carbodiimide bonds). Generally, the polyurethane contains urethane groups. The polyurethanes utilized in the aqueous sealing compositions and sealing films described herein may be prepared using methods known in the art. The polyurethanes of the aqueous sealing composition of the present inventions are polyester polyurethanes, polycarbonate polyurethanes, and mixtures thereof. The polyurethane of the aqueous sealing composition may have weight average molecular weight (MW) of from 1,000 to 2,000,000 Daltons (grams per mole), from 10,000 to 300,000 Daltons, or from 15,000 to 200,000 Daltons. The polyurethane may be added in the aqueous sealing composition as an aqueous solution, an aqueous dispersion or an aqueous emulsion, or a latex.

The content of the polyurethane in the aqueous sealing composition may be from 7 to 29 weight %, from 8 to 25 weight %, from 12 to 22 weight %, or from 14 to 20 weight % by weight of the aqueous sealing composition excluding water.

The aqueous sealing composition may comprise a polyurethane crosslinker (or otherwise called, polyurethane crosslinking agent). The content of the polyurethane crosslinker in the aqueous sealing composition may be from 0.1 to 8 weight % of the polyurethane crosslinker by weight of the aqueous sealing composition excluding water. During the curing of the aqueous sealing composition to prepare a sealing film, the polyurethane crosslinker forms chemical bonds between the polyurethane of the aqueous sealing composition and potentially with the polymer molecules of the microcells, increasing the adhesion between the sealing film and the microcells. The polyurethane crosslinker is preferably soluble or dispersible in the aqueous carrier of the aqueous sealing composition. The crosslinker may be a monomer, an oligomer or a polymer. Examples of polyurethane crosslinkers include polyisocyanates, multifunctional polycarbodiimides, multifunctional aziridines, silane coupling agents, boron/titanium/zirconium-based crosslinkers, or melamine formaldehydes. Polycarbodiimide crosslinkers are reactive at acidic pH conditions. Preferably, the polyurethane crosslinker is free of sulfosuccinate surfactants. The content of the polyurethane crosslinker in the aqueous sealing composition may be from 0.2 to 6 weight %, from 0.4 to 4 weight %, from 0.5 to 3 weight %, from 0.6 to 2 weight percent, or from 0.7 to 1.8 weight % by weight of the aqueous sealing composition excluding water.

The inventors of the present invention found that aqueous sealing compositions comprising a combination of a water soluble poly(vinyl alcohol) homopolymer or poly(vinyl alcohol-co-ethylene) copolymer and a polyurethane, wherein the interfacial tension between the water soluble poly(vinyl alcohol) polymer or poly(vinyl alcohol-co-ethylene) copolymer and the polyurethane is less than 2 mN/m, can form sealing films with excellent performance.

Extensive experimental work also revealed that excellent performance was also observed from aqueous sealing compositions comprising a combination of a water soluble poly(vinyl alcohol) homopolymer or poly(vinyl alcohol-co-ethylene) copolymer and a polyurethane, wherein the polar component of the surface energy of the polyurethane is from 10 to 20 mN/m.

The aqueous sealing composition may further comprise a water soluble ether from 1 to 40 weight % by weight of the aqueous sealing composition excluding water. The aqueous sealing composition may comprise the water soluble ether from 1 to 30 weight %, from 1 to 25 weight %, from 1 to 22 weight %, from 1 to 20 weight %, from 1 to 15 weight %, from 1 to 10 weight %, from 1 to 5 weight %, or from 1 to 3 weight % by weight of the aqueous sealing composition excluding water. The content of the water soluble ether in the aqueous sealing composition may be higher than 0.2 weight %, higher than 0.5 weight %, higher than 1 weight %, higher than 2 weight %, higher than 5 weight %, higher than 6 weight %, higher than 7 weight %, higher than 8 weight %, or higher than 10 weight % by weight of the aqueous sealing composition excluding water. The content of the water soluble ether in the aqueous sealing composition may be lower than 40 weight %, lower than 30 weight %, lower than 20 weight %, lower than 15 weight %, lower than 10 weight %, lower than 5 weight %, or lower than 2 weight % by weight of the aqueous sealing composition excluding water.

The water soluble ether has weight average molecular weight of from 75 to 5,000 Dalton (grams per mole). The water soluble ether may have weight average molecular weight of from 85 to 3,000 Dalton, from 90 to 1,000 Daltons, from 90 to 500 Daltons, or from 90 to 300 Daltons. The water soluble ether may have weight average molecular weight higher than 75, higher than 90 higher than 100, or higher than 200. The water soluble ether may have weight average molecular weight lower than 5,000, lower than 3,000, lower than 1,000, lower than 500, lower than 300, lower than 200, or lower than 150.

The water soluble ether is a polar compound that is soluble in water and polar organic solvents. The water soluble ether may be represented by Formula II, Formula III, or Formula IV.

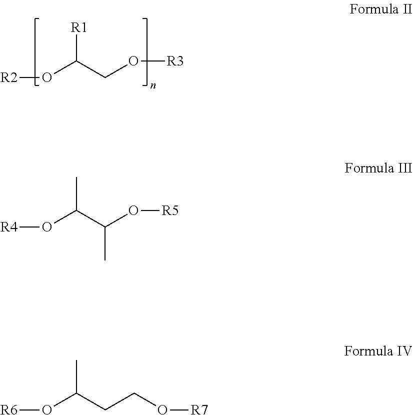

The value of n is from 1 to 145. The value of n may be from 1 to 100, from 1 to 50, from 1 to 20, from 1 to 10, from 1 to 5, from 1 to 4, from 1 to 3, or from 1 to 2. R1 is hydrogen, methyl or ethyl group; R2, R3, R4, R5, R6, and R7 are selected independently from the group consisting of hydrogen, linear or branched alkyl group comprising from 1 carbon atom to 6 carbon atoms, phenyl, and benzyl group. Formula II comprises at least one ether functional group. Formula III comprises at least one ether functional group. Formula IV comprises at least one ether functional group.

The water soluble ether may be selected from the group consisting of ethylene glycol monomethyl ether, ethylene glycol monoethyl ether, ethylene glycol mono-n-propyl ether, ethylene glycol monoisopropyl ether, ethylene glycol n-monobutyl ether, ethylene glycol monoisobutyl ether, ethylene glycol mono-t-butyl ether, ethylene glycol monobenzyl ether, ethylene glycol monophenyl ether, ethylene glycol dimethyl ether, ethylene glycol diethyl ether, ethylene glycol di-n-propyl ether, ethylene glycol diisopropyl ether, diethylene glycol monomethyl ether, diethylene glycol monoethyl ether, diethylene glycol mono-n-propyl ether, diethylene glycol monoisopropyl ether, diethylene glycol n-monobutyl ether, diethylene glycol monoisobutyl ether, diethylene glycol mono-t-butyl ether, diethylene glycol monobenzyl ether, diethylene glycol monophenyl ether, diethylene glycol dimethyl ether, diethylene glycol diethyl ether, diethylene glycol ethyl methyl ether, diethylene glycol di-n-propyl ether, diethylene glycol diisopropyl ether, diethylene glycol di-n-butyl, triethylene glycol monomethyl ether, triethylene glycol monoethyl ether, triethylene glycol mono-n-propyl ether, triethylene glycol monoisopropyl ether, triethylene glycol n-monobutyl ether, triethylene glycol monoisobutyl ether, triethylene glycol mono-t-butyl ether, triethylene glycol monobenzyl ether, triethylene glycol monophenyl ether, triethylene glycol dimethyl ether, triethylene glycol diethyl ether, triethylene glycol di-n-propyl ether, triethylene glycol diisopropyl ether, tetraethylene glycol monomethyl ether, tetraethylene glycol monoethyl ether, triethylene glycol monophenyl ether, tetraethylene glycol dimethyl ether, polyethylene glycol monomethyl ether, polyethylene glycol monoethyl ether, polyethylene glycol monophenyl ether, propylene glycol monomethyl ether, propylene glycol monoethyl ether, propylene glycol mono-n-propyl ether, propylene glycol monoisopropyl ether, propylene glycol mono-n-butyl ether, propylene glycol monoisobutyl ether, propylene glycol monophenyl ether, propylene glycol dimethyl ether, propylene glycol diethyl ether, dipropylene glycol monomethyl ether, dipropylene glycol monoethyl ether, dipropylene glycol mono-n-propyl ether, dipropylene glycol monoisopropyl ether, dipropylene glycol mono-n-butyl ether, dipropylene glycol monoisobutyl ether, dipropylene glycol dimethyl ether, dipropylene glycol diethyl ether, dipropylene glycol di-n-propyl ether, dipropylene glycol diisopropyl ether, tripropylene glycol monomethyl ether, tripropylene glycol monoethyl ether, tripropylene glycol mono-n-propyl ether, tripropylene glycol monoisopropyl ether, tripropylene glycol mono-n-butyl ether, tripropylene glycol monoisobutyl ether, or mixtures thereof.

The aqueous sealing composition may also comprise a wetting agent, also called surfactant. Non-limiting examples of wetting agents include FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn. Wetting agents may increase the affinity between the sealing film and the microcells, enhance the interfacial area between them, and improve the adhesion of the sealing film to the microcells and provide a more flexible coating process. The content of the surfactant in the aqueous sealing composition may be from 0.001 to 5 weight %, from 0.01 to 5 weight %, or from 0.01 to 2 weight % by weight of the aqueous sealing composition excluding water.

The aqueous sealing composition may comprise water in a content of from 20 to 95 weight %, from 50 to 94 weight %, from 70 to 92 weight %, from 75 to 90 weight %, or from 80 to 88 weight % by weight of the aqueous sealing composition.

The aqueous sealing composition may also comprise a pH adjusting agent. The pH adjusting agent is added into the aqueous sealing composition to adjust its pH to a value of from 6.5 to 8.5. An example of a pH adjusting agent is ammonium hydroxide, but a variety of acids and bases can be used. The pH adjusting agent increases the pH of the aqueous sealing composition, which may decrease the rate of crosslinking of the aqueous sealing composition before its use, and provides optimum pH condition for the rheology modifier to interact with the particles of the aqueous sealing composition, improving its efficacy. The pH adjusting agent may be used at a content of from 0.2 weigh % to 1 weight % by weight of the aqueous sealing composition excluding water.

The aqueous sealing composition can be used to for a sealing film by application of the aqueous sealing composition and drying or curing the aqueous sealing composition. The sealing film may comprise most of the ingredients of the aqueous sealing composition. If the aqueous composition comprises a polyurethane crosslinker, the polyurethane crosslinker is incorporated into the polyurethane polymer of the sealing film during curing. In addition, the water of the sealing composition is evaporated during the drying or curing of the aqueous sealing composition towards the preparation of the sealing film. If the aqueous sealing composition contains a water soluble ether, the formed sealing film also contains the water soluble ether of the aqueous sealing composition, although some of the water soluble ether is evaporated during the formation of the sealing film. If there is any residual or absorbed water or moisture or water soluble ether in the sealing film, the disclosed contents of the components of the sealing film are calculated as weight % of the component by weight of excluding the residual water, the residual water soluble ether, and the absorbed water, unless otherwise stated.

The sealing film comprises from 15 to 60 weight % of a water soluble poly(vinyl alcohol) homopolymer or poly(vinyl alcohol-co-ethylene) copolymer by weight of the sealing film, from 7 to 29 weight % of a polyurethane by weight of the sealing film, and from 0.05 to 10 weight % of a rheology modifier by weight of the sealing film. The poly(vinyl alcohol) homopolymer has a degree of hydrolysis of from 90% to 99.5%. The poly(vinyl alcohol-co-ethylene) copolymer has a degree of hydrolysis of from 90% to 99.5% and ethylene content of less than 10%. The rheology modifier is a Hydrophobically Modified Ethoxylated Urethane (HEUR) or an Alkali Swellable Emulsion polymer (ASE). The sealing film may further comprise a conductive filler. The conductive filler may be carbon black. The sealing film may comprise from 11 to 60 weight %, from 24 to 55 weight %, from 29 to 50 weight %, or from 30 to 45 weight % of conductive carbon black by weight of the sealing film.

The sealing film may comprise a surfactant (wetting agent). The content of the surfactant in the sealing film may be from 0.001 to 5 weight %, from 0.01 to 5 weight %, or from 0.01 to 2 weight % by weight of the aqueous sealing composition. The surfactant may be an anionic, cationic, zwitterionic, or nonionic surfactant. The surfactant may be a fluorosurfactant. The surfactant may be a silicone surfactant, which contain a polydimethylsiloxane group in its molecular structure.

The sealing film may comprise a water soluble ether from 4.5 to 25 weight % by weight of the sealing film. The sealing film may comprise the water soluble ether from 4.5 to 10 weight %, or from 5 to 9 weight %, from 5 to 8 weight %, or from 5 to 7 weight %, by weight of the sealing film. The content of the water soluble ether in the sealing film may be higher than 4.5 weight %, higher than 5 weight %, higher than 6 weight %, higher than 7 weight %, higher than 8 weight %, higher than 9 weight %, or higher than 10 weight % by weight of the sealing film. The content of the water soluble ether in the sealing film may be lower than 25 weight %, lower than 20 weight %, lower than 15 weight %, lower than 10 weight %, or lower than 5 weight % by weight of the sealing film.

The addition of the water soluble ether in the aqueous sealing composition and the sealing film is believed to reduce the electrical resistance of the interface of the sealing film and one or both the adjacent layers, such as the sealing film-adhesive interface and the sealing film-electrophoretic medium interface. This reduction of the electrical resistance of the interface was experimentally shown with volume resistivity measurements and with Electrical Impedance Spectroscopy experiments, as shown in the Examples Section. Importantly, this electrical resistance of the interface did not affect the electrical conductivity of the sealing film itself. In fact, as the data showed, the inventive sealing film has higher volume resistivity than that of a control film that comprise no water soluble ether. As mentioned above, higher volume resistivity of the sealing film contributes to lower blooming, which is well known phenomenon in the electro-optic field.

The sealing film prepared by the aqueous sealing composition can be used for sealing the microcells of an electro-optic device. The electro-optic device comprises a conductive layer, a microcell layer comprising a plurality of microcells, each microcell including an opening, each microcell comprising an electrophoretic medium, the electrophoretic medium comprising charged particles in a non-polar carrier, a sealing film, the sealing film spanning the opening of each microcell, an adhesive layer; and an electrode layer.

In general, the sealing film of electro-optic devices plays an important role in the display performance. Inferior barrier property of a sealing film results in non-polar fluid of the electrophoretic medium escaping from the electro-optic material layer over time, which leads to a severe deteriorating the electro-optic performance of the display. It was observed that increasing the content of poly(vinyl alcohol) homopolymer or poly(vinyl alcohol-co-ethylene) copolymer of the sealing film improves its barrier properties. However, sealing films having high content of poly(vinyl alcohol) homopolymer or poly(vinyl alcohol-co-ethylene) copolymer increase its moisture absorption, which is also undesirable.

The inventors of the present invention surprisingly found that aqueous compositions comprising a rheology modifier selected from the group consisting of HEUR and ASE, the sealing film improve the coating quality of the sealing film. That is, they reduce coating defects. If there are defects, the electro-optic performance of the corresponding device is inferior. Coating defects may be related to dewetting, delamination, chatter, or Cloudy Spot Mura (CSM). These effects will be described in detail below. Specifically, reduced defects (higher coating quality) of the sealing film was observed when (a) the Viscosity Ratio is lower than 7, the Viscosity Ratio is from 1 to 7, from 2 to 7, or from 0.5 to 7, (b) the H-B Rate Index is 0.7 or higher, from 0.7 to 1, from 0.7 to 0.9, or from 0.7 to 2, and (c) the thixotropy index is 1.5 or higher, or from 1.5 to 3.

Viscosity Ratio of the aqueous sealing composition is determined as the ratio of the viscosity at low shear rate divided by the viscosity at high shear rate as described in the Examples section. The H-B Rate Index of the aqueous sealing composition is determined by measuring the viscosity of the composition via a shear rate ramp, constructing the graph of Stress versus shear rate and analyzing the graph based on the Herschel-Bulkley model as described in the Example section. Thixotropy index is the ratio of viscosities measured via a thixotropic loop experiment, where low to high shear rates are applied to the aqueous composition followed by shear rates from high to low shear rates. The thixotropy index indicates the thixotropic behavior of the aqueous sealing composition. The inventors performed detailed studies of the rheology characteristics of various aqueous sealing compositions, then used the aqueous compositions to form devices having the corresponding films and determined the coating quality and performance of such sealing films. It was surprisingly found that aqueous compositions comprising HEUR and ASE rheology modifiers provide sealing films exhibiting better performance and significantly lower defects. It was also observed that the use of a fluorosurfactant in the aqueous composition showed smaller surfactant-rheology modifier interactions; that is, the fluorosurfactant content affects less the rheology characteristics of the aqueous composition compared to other surfactants, enabling a better flexibility in adjusting the surface energy of the resulting sealing film, which was shown to have a significant effect on the sealing film performance. Specifically, as mentioned above, improved performance is observed when a combination of poly(vinyl alcohol) homopolymer or poly(vinyl alcohol-co-ethylene) copolymer and polyurethane is used, wherein the interfacial tension between the poly(vinyl alcohol) polymer or poly(vinyl alcohol-co-ethylene) copolymer and the polyurethane is less than 2 mN/m. Furthermore, the inventors of the present invention surprisingly found that optimum performance is also observed when a combination of poly(vinyl alcohol) homopolymer or poly(vinyl alcohol-co-ethylene) copolymer and polyurethane is used, wherein the polar component of the surface energy of the polyurethane is from 10 to 20 mN/m.

These and other aspects of the present invention will be further appreciated upon consideration of the following Examples, which are intended to illustrate certain particular embodiments of the invention but are not intended to limit its scope, as defined by the claims.

### EXAMPLES

Methods of Evaluation of Aqueous Sealing Composition and Sealing Films.

A. Example of Preparation of the Aqueous Sealing Compositions:

A1. Example of preparation of carbon black dispersion. An aqueous solution of poly(vinyl alcohol) homopolymer or poly(vinyl alcohol-co-ethylene) copolymer was prepared containing 20 weight % of the polymer by volume of the solution. In one example, the polymer is poly(vinyl alcohol-co-ethylene) copolymer (Exceval™ RS-1717, supplied by Kuraray). That is, the solution contains 200 g of polymer per liter of the solution. The carbon black powder is mixed with the aqueous solution of the poly(vinyl alcohol) homopolymer or poly(vinyl alcohol-co-ethylene) copolymer. In one example, an aqueous solution comprising 106 g of poly(vinyl alcohol-co-ethylene) copolymer was mixed with 162 g of carbon black (Nerox® 3500, supplied by Orion Engineered Carbon). The dispersion was mixed in an overhead mixer (Hei-Torque Value 200) for 30 minutes at 300 rpm. The dispersion was then recirculated in a Generation 1 Q1375 Flocell Sonicator, wherein the jacket of the sonicator is cooled using chilled water of 10° C., and at 100% amplitude for 3 hours and 23 minutes. The dispersion was continuously stirred until it was used to prepare the sealing composition.

A2. Example of preparation of aqueous sealing composition. Into a container, an aqueous polyurethane dispersion were combined with a wetting agent, and an aqueous solution of poly(vinyl alcohol) homopolymer or poly(vinyl alcohol-co-ethylene) copolymer. In one example, 227.17 g of 35 weight % polyurethane aqueous dispersion (L3838 aqueous dispersion, supplied by Hauthaway), were mixed with 683.2 g of an aqueous solution of poly(vinyl alcohol-co-ethylene) copolymer (containing 20 weight % of copolymer by volume of the solution). In the example, the poly(vinyl alcohol-co-ethylene) copolymer was Exceval™ RS-1717, supplied by Kuraray. The mixture was mixed for 10 minutes at 90 rpm using a Hei-torque Value 200 overhead mixer. The appropriate amount of a crosslinker was added and the mixture was mixed for an additional 60 minutes at 90 rpm. The appropriate amount of the carbon black dispersion prepared in A1 was added (in one example 0.530 L) and the resulting dispersion was mixed for 60 minutes at 500 rpm. The pH was then adjusted to 6.5-8.5 using ammonium hydroxide and the dispersion was mixed for an additional 30 minutes. The appropriate amount of a rheology modifier was added into the dispersion dropwise and the mixing continued for another 60 minutes. Then, the dispersion was degassed under reduced pressure (25 mmHg) for 5 days. The resulting aqueous sealing composition was used for the preparation of a sealing film of the corresponding device within 7 days of the preparation of the sealing composition.

B1. Example of Preparation of Sealing Film Using a Drawdown Method.

The sealing composition prepared in A2 above was coated on the Indium-Tin Oxide (ITO) side of an ITO-PET film using a Gardco drawdown coater. A 15-mil gap and an eight path square applicator was used. The drawdown speed was set at 2 m/min to target a dry film thickness of 30+/−2 μm. The coating was dried at a 100° C. oven for 15 minutes. The dried film was conditioned at 25° C. and 55% RH for 24 hours.

B2. Example of Preparation of Sealing Film Using a Roll-to-Roll Coating Line.

A sealing composition prepared in A2 above was coated on the Indium Tin Oxide (ITO) side of an ITO-PET thin film at dry thickness of 30 μm, using a slot die in a roll-to-roll coating line at the speed of 9 ft/min. The film travelled through a convention oven consisting of four heating zones at a speed of 9 ft/min. Each heating zone had a length of 5 feet. The first zone was set at temperature of 80° C., and the rest heating zones were set at temperature of 100° C. Once the dried sealing film on ITO-PET has passed through the drying ovens, the film is cut into 3 sections, each approximately 24-30 inches in length and placed in a cleanroom controlled environment at temperature of 25° C. and 55% Relative Humidity (RH).

C. Determination of the Surface Energy of the Film.

The surface energy of the prepared sealing films (as described in B1 above) were measured using a Drop Shape Analyzer supplied by Kruss GmbH. Using a syringe with a needle, a 2.6 μL size droplet of deionized water was placed on the top surface of the sealing film and the contact angle between the liquid (water) and the sealing film was measured. The measurement was repeated by replacing the water droplet with a diiodomethane droplet. By performing contact measurements using these two liquids of known surface energy, the surface energy of the film was calculated. The contact angle measurement was repeated three times for each liquid (water and diiodomethane). The contact angle between the liquid and the top surface of the sealing film was measured using the high resolution camera after 5 s, 30 s, and 55 s from the time that the droplet was placed on the sample film. Then, using the Owens, Wendt, Rabel and Kaelble (OWRK) method, the total surface energy and its polar and dispersive components were calculated for each data point. The reported surface energies were averages of 9 data points (3 droplets×3 time scales).

D. Preparation for the Electro-Optic Device.

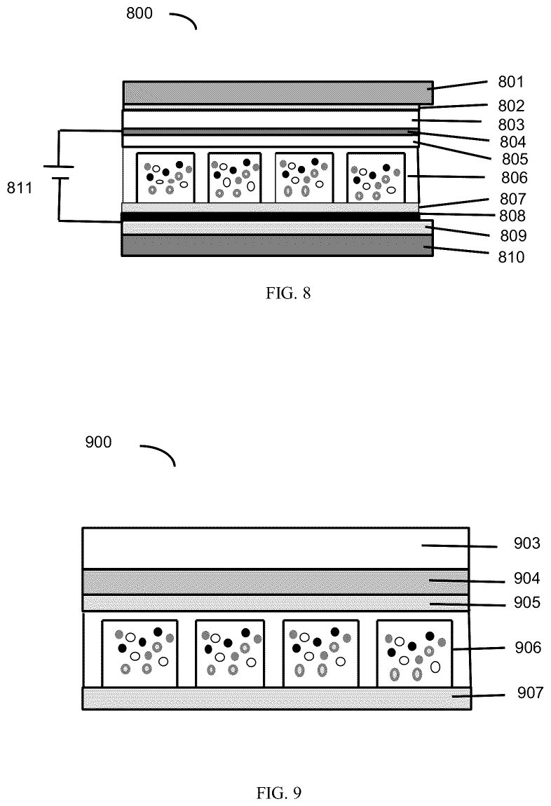

An electro-optic device was prepared by filling a plurality of microcells with a mixture of electrically charged pigment particles (white, cyan, magenta, and yellow) in Isopar E. The white and yellow particles were negatively charged, and the cyan and magenta particles were positively charged. Then, the aqueous sealing composition was coated on the opening of the microcells as described in B above. The device illustrated in FIG. 8 was constructed. The electro-optic device 800 comprised in order: a protective film 801, a first adhesive layer 802 that was optically clear, a substrate 803, a light-transmissive conductive layer 804, a primer layer 805, a microcell layer 806, a sealing film 807, a second adhesive layer 808, an ITO electrode layer 809, and a Glass layer 810. A source of electric field 811 electrically connected the light-transmissive conductive layer 804 with the ITO electrode layer 809. Waveforms were applied through this source to drive the desired optical state. The first light-transmissive layer 802 had approximate thickness of 25 μm. The substrate 803 had approximate thickness of 100 μm. The primary layer 1005 had approximate thickness of 0.4 μm. The microcell layer 806 comprised a plurality of microcells. Each microcell had an approximate bottom thickness of 0.4 μm and approximate height of 10 μm. The sealing film 807 had approximate thickness of 10 μm and the second adhesive layer had approximate thickness of 4.5 μm.

E. Determination of Interfacial Tension of Polymers.

The interfacial tension between Polymer 1 and Polymer 2 for the specific combinations of polymers was calculated from surface tension values (determined via the method described in C above). The calculation of the interfacial tension between the two ingredients was performed by using the values for the surface energy of each ingredient and the following geometric equation:

σ_{AB}=σ_{A}+σ_{B}−2(\sqrt{σ_{A}^{D}·σ_{B}^{D}}+\sqrt{σ_{A}^{P}·σ_{B}^{P}})

where σ_{AB} is the interfacial tension between polymer A and B; σ_{A} is the total surface energy of polymer A; σ_{B} is the total surface energy of polymer B; σ_{A}^{D} and; σ_{B}^{D} is dispersive component of the surface energy of polymer A and B, respectively; σ_{A}^{D} and σ_{B}^{D} are polar component of surface.

Analogously, the interfacial tension between a sealing film and an adhesive layer may be measured. An adhesive layer standard comprising polyurethane formed by an aqueous dispersion of water dispersible polyurethane.

F. Evaluation of Barrier Property of Sealing Films Towards Non-Polar Fluids.

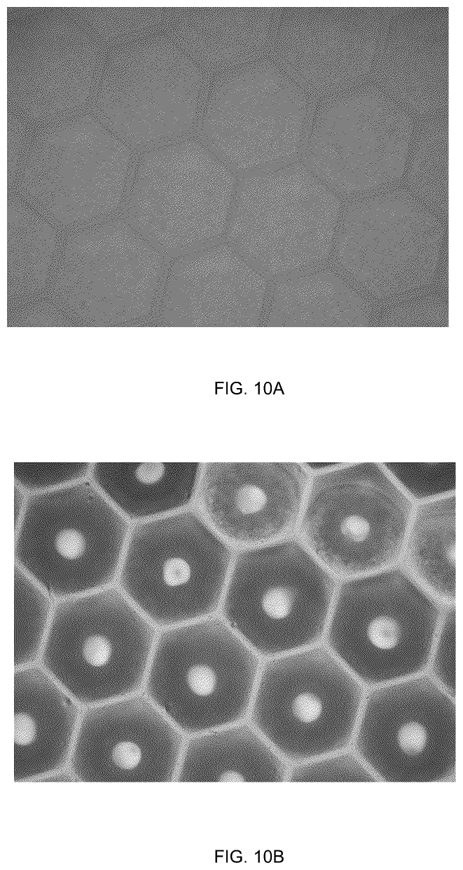

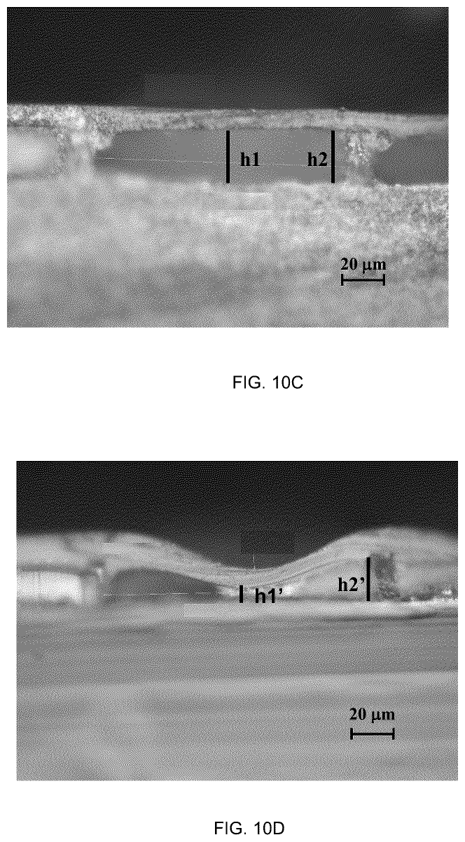

An aqueous dispersion was prepared by mixing 10 grams of poly(vinyl alcohol) homopolymer or 10 grams of poly(vinyl alcohol-co-ethylene) copolymer and 10 grams of polyurethane in 100 mL of water. The dispersion was used as an aqueous polymer composition to form a sealing film of a device 900 illustrated in FIG. 9. The sealing film was formed by the method described in B1 above. The device 900 comprised in order: a substrate 903, a light-transmissive conductive layer 904, a primer layer 905, a microcell layer 906, and a sealing film 907. The microcell included an electrophoretic medium comprising white, black, and red pigment particles in Isopar E. The device 900 was stored at 70° C. for at least 24 hours. After this period, the electro-optic device was inspected using an optical microscopy for sagging of the sealing film caused by the loss of the non-polar fluid of the electrophoretic medium. If the distance between the bottom of the inspected microcavity and the lowest point of the bottom surface of the sealing film is less than 85% of the distance between the bottom of the microcavity and the highest point of the lower surface of the sealing film at the same microcell, the aqueous polymer composition is labeled as “Fail” for its barrier property. Otherwise, that is, if the distance between the bottom of the inspected microcell and the lowest point of the sealing film is 85% or more of the distance between the bottom of the microcell and the highest point of the bottom surface of the sealing film at the inspected microcell, the sealing the aqueous polymer composition is labeled as “Pass” for its barrier property. For example, the aqueous polymer composition that was used to prepared the electro-optic device illustrated in FIG. 10C was labeled as “Pass” because the ratio of h2:h1 is 1 (no sagging), whereas the aqueous polymer composition that was used to prepared the electro-optic device illustrated in FIG. 10D was labeled as “Fail” because the ratio of h2:h1 is 35% (sagging level of more than 85%). The barrier property evaluation may also be performed qualitatively by observing the prepared electro-optic device by an optical microscopy looking from the viewing surface of the device. Devices that comprise severely sagged sealing films have significantly different appearance from devices that comprise sealing films with good barrier property towards non-polar fluids (non-uniform versus uniform surface). For example, microcells having aqueous polymer composition that correspond to sealing film of FIG. 10C (“Pass”) appears uniform as shown in FIG. 10A, as opposed to microcells having aqueous polymer composition that correspond to sealing film of FIG. 10D (“Fail”), which appears non-uniform as shown in FIG. 10B. The evaluation of various combinations of (1) poly(vinyl alcohol) homopolymer or Poly(vinyl alcohol-co-ethylene) copolymer and (2) polyurethane are shown in Table 3. Polymer 1 is poly(vinyl alcohol) homopolymer or poly(vinyl alcohol-co-ethylene) copolymer, and Polymer 2 is Polyurethane. Details on the commercial material of Polymer 1 and Polymer 2 can be found in Table 4.

G. Method of Determination of the Thixotropy Index of Aqueous Sealing Compositions.

The thixotropic index (T.I.) was used to describe one aspect of the rheological behavior of the aqueous sealing composition. The thixotropic index is the ratio of the viscosity measured during a thixotropic loop test via a rheometer. The thixotropic loop test is a measurement of viscosities at different shear rates via a shear rate ramp from low shear (10⁻⁴ l/s) to high shear (10¹ l/s) in the first flow ramp (flow ramp 1), then high shear to low shear in the second flow ramp (flow ramp 2) to create a shear loop. The thixotropic index was calculated using the equation below for the viscosity values at 10⁰ l/s shear rate, where η(A) is the viscosity at 10⁰ l/s of flow ramp 1 and η(B) is the viscosity at 10⁰ l/s of flow ramp 2.

T.I.=η(A)/η(B)

A high thixotropic index means the fluid has more shear-thinning behavior, while a low thixotropic index means the fluid has less shear-thinning behavior and is more Newtonian. As shown in the experimental reuslts below, thixotropic index of the aqueous sealing composition higher than 1.5, or between 1.5 and 3, resulted in improved sealing film coating quality with lower defects (reduced dewetting and chatter).

H. Method of Determination of H-B Rate Index of Aqueous Sealing Compositions.

The H-B Rate Index (or Herschel-Bulkley Rate Index) was also used to describe the rheological behavior of aqueous sealing compositions. The shear stress of the aqueous sealing composition was determined for shear rates from 0 to 600 l/s. Herschel-Bulkley parameters were fit to the data and calculated by the TRIOS software using the Herschel-Bulkley equation, σ=σ_{y}+K γⁿ, where σ is shear stress, K is consistency coefficient (viscosity), γ is shear rate, n is H-B Rate Index, and σ_{y} is yield stress. The H-B Rate Index n quantifies the fluid behavior of the sealing fluid. If n<1, then the fluid has shear-thinning behavior. If n>1, then the fluid has shear-thickening behavior. If n=1 and the yield stress (σ_{y}) equals zero, then the fluid is Newtonian. It was observed that HASE rheology modifiers (Solthix™ A100 and Rheovis® HS1212) had lower H-B Rate Indexes than those of ASE rheology modifiers (Rheovis® AS1130) and HEUR rheology modifiers (Rheovis® PU 1191, ACRYSOL™ RM-8W, OPTIFLO® 3300), aqueous sealing composition comprising ASE and HEUR rheology modifiers having improved coating quality (less defects).

I. Method of Viscosity Ratio of Aqueous Sealing Compositions.

Viscosity Ratios of aqueous sealing compositions were determined by acquiring the rheology profile of each aqueous sealing composition using an HR30 Discovery Series Rheometer from TA Instruments and a parallel plate sensor having diameter of 40.0 mm and 1000.0 μm geometry gap with the Peltier plate maintained the temperature at 25° C. The viscosity of the aqueous sealing composition was measured using a flow ramp with a shear rate range from 10⁻⁴ Hz to 1000 Hz, taking two points per decade. The Viscosity Ratio is calculated as the ratio of the low shear viscosity (at 10⁻³ l/s) divided by the high shear viscosity (at 10³ l/s). That is, the equation Viscosity Ratio=η(L)/η(H) was used, where η(L) was the viscosity at shear rate of 10⁻³ l/s and η(H) was the viscosity at shear rate of 10³ l/s.

J. Method of Determination of Coating Quality of Sealing Films.

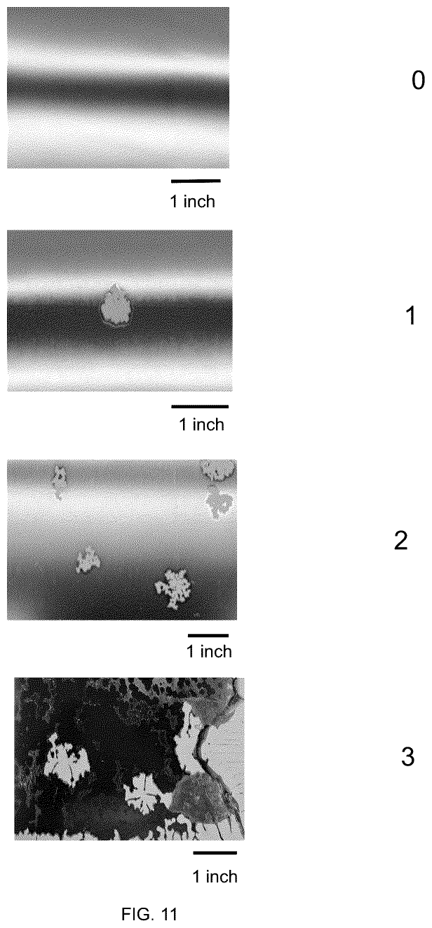

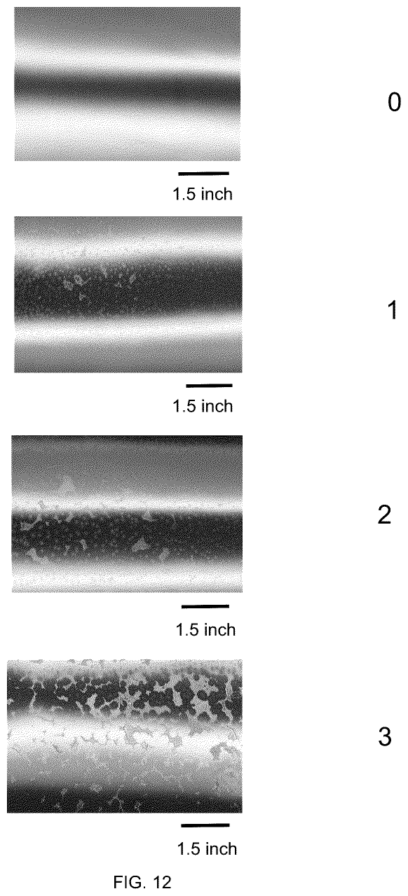

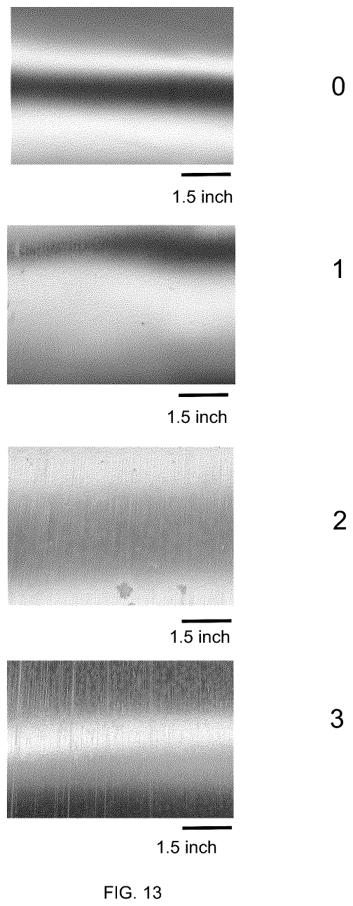

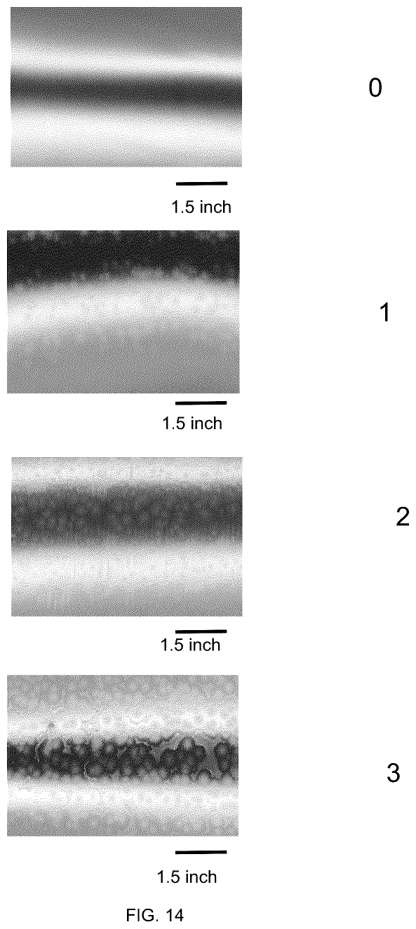

A Front Plane Laminate comprising a microcell layer filled with electrophoretic medium was coated with aqueous sealing composition. The resulting panel was cut into panels having length of approximately 32 inches and inspected for coating quality. The panel was placed on a surface under fluorescent light (5000K fluorescent bulb) and the sealing film was visually inspected. The coating quality was determined based on four different quality defects, such as Dewetting, Delamination, Chatter and Cloudy Spot Mura (CSM). Each of the sealing film was graded based on a ranking system for each quality defect. Specifically, the defects were graded on a scale of 0 to 3, where 0 contained no defects and 3 contained the highest level of defect. That is, larger numbers indicate inferior quality. FIG. 11 provides examples of sealing films that correspond to the Dewetting ranking system. FIG. 12 provides examples of sealing films that correspond to the Delamination ranking system. FIG. 13 provides examples of sealing films that correspond to the Chatter ranking system. FIG. 14 provides examples of sealing films that correspond to the Cloudy Spot Mura ranking system.

Dewetting occurs when the sealing fluid dewets from the filled microcell layer before drying is complete, leaving behind a spot or spots of missing sealing fluid. Sealing films with more dewetting spots were given a higher dewetting grade. Sealing films with 1-2 spots present received a 1 grade, 3-5 spots received a 2 grade, and 6 or more spots received a 3 grade.

Delamination occurs when the dried sealing film separates/delaminates from the filled microcells. Panels with 2-5 spots of small size (less than 0.25 cm) received a 1 grade, 5-10 spots of small or medium size (less than 1.25 cm) received a 2 grade, and sealing films with large spots (greater than 1.25 cm) or with spots across their entire surface received a 3 grade.

Chatter describes the vertical lines that occur across the panel. If light lines were present, but only visible at certain angles of light reflection, then a 1 grade was given. A 2 grade was given when the lines were easily visible at all angles. If the lines were dark and pronounced, then a 3 grade was given.

Cloudy Spot Mura (CSM) is used to describe circular spots that are often present on the sealing film surface. The size, shape, and boldness of the CSM changes depending on many factors including, but not limited to, sealing formulation, electrophoretic medium, and coating parameters. CSM that were light and/or small in size (less than 0.25 cm) without nucleation spots in the center (small dark center points) were given a 1 grade. If nucleation was visible in the CSM, then they were graded as a 2. If the CSM was extremely bold and/or large in size (greater than 1 cm) in addition to having nucleation, then they were given a grade of 3.

Evaluation Results

Unless otherwise stated, the amounts of the components in the disclosed compositions in the following tables are provided in weight percent of the component by weight of the composition excluding water. The term Q.S. (quantum satis) is used in some compositions to represent the content of the water carrier. It means that the content of water in the composition is as much as is needed to achieve the total 100% of the composition, and not more.

If there was any residual or absorbed water or moisture in the sealing film, the disclosed contents of the components of the sealing film are calculated as weight % of the component by weight of excluding the residual or absorbed water, unless otherwise stated.

The example compositions having numbers ending in the letter F correspond to sealing film compositions, whereas the rest of the example compositions correspond to aqueous sealing compositions. The example of sealing film composition correspond to the same Example number (with a suffix F) as the aqueous sealing compositions that is used to prepare the sealing film composition. Thus, Ex. 1F (sealing film composition) is prepared from Ex 1 (aqueous sealing composition).

TABLE 1A
Aqueous sealing composition comprising various rheology modifiers.

| | | | | | Comparative | Comparative |
|---|---|---|---|---|---|---|
| Ingredients | Ex. 1 | Ex. 2 | Ex. 3 | Ex. 4 | Ex. 5 | Ex. 6 |
| Poly(vinyl alcohol-co- | 4.60 | 4.60 | 4.60 | 4.60 | 4.60 | 4.60 |
| ethylene) copolymer [1] | | | | | | |
| Polyurethane aqueous | 2.72 | 2.72 | 2.72 | 2.72 | 2.72 | 2.72 |
| dispersion [2] | | | | | | |
| Carbon black [3] | 10.05 | 10.05 | 10.05 | 10.05 | 10.05 | 10.05 |
| Polycarbodiimide | 0.17 | 0.17 | 0.17 | 0.17 | 0.17 | 0.17 |
| (Multifunctional | | | | | | |
| polycarbodiimide [4] | | | | | | |
| Hydrophobically | | | | | 0.09 | |
| modified alkali | | | | | | |
| swellable acrylic | | | | | | |
| emulsion rheology | | | | | | |
| modifier [5] | | | | | | |
| Hydrophobically | | | | | | 0.09 |
| modified alkali | | | | | | |
| swellable acrylic | | | | | | |
| emulsion rheology | | | | | | |
| modifier [6] | | | | | | |
| Alkali-swellable acrylic | 0.09 | | | | | |
| emulsion rheology | | | | | | |
| modifier [7] | | | | | | |
| Hydrophobically | | 0.09 | | | | |
| modified Ethoxylated | | | | | | |
| Urethane copolymer | | | | | | |
| rheology modifier [8] | | | | | | |
| Hydrophobically | | | 0.09 | | | |
| modified Ethoxylated | | | | | | |
| Urethane copolymer | | | | | | |
| rheology modifier [9] | | | | | | |
| Hydrophobically | | | | 0.09 | | |
| modified Ethoxylated | | | | | | |
| Urethane copolymer | | | | | | |
| rheology modifier [10] | | | | | | |
| Siloxane | 0.13 | 0.13 | 0.13 | 0.13 | 0.13 | 0.13 |
| Polyalkyleneoxide | | | | | | |
| Copolymer [11] | | | | | | |
| Ammonium Hydroxide | | | | | | |
| to adjust pH to 6.5-8.5 | | | | | | |
| Deionized water | Q.S. | Q.S. | Q.S. | Q.S. | Q.S. | Q.S. |
| H-B Rate Index | 0.76 | 0.87 | 0.86 | 0.86 | 0.61 | 0.66 |
| Viscosity Ratio | 3.9 | 2.2 | 3.8 | 2.2 | 9.0 | 7.4 |

TABLE 1B
Sealing films formed by aqueous sealing compositions comprising
various rheology modifiers.

| | Ex. | Ex. | Ex. | Ex. | Comparative | Comparative |
|---|---|---|---|---|---|---|
| Ingredients | 1F | 2F | 3F | 4F | Ex. 5F | Ex. 6F |
| Poly(vinyl alcohol-co- | 25.90 | 25.90 | 25.90 | 25.90 | 25.90 | 25.90 |
| ethylene) copolymer [1] | | | | | | |
| Polyurethane aqueous | 16.27 | 16.27 | 16.27 | 16.27 | 16.27 | 16.27 |
| dispersion [2] | | | | | | |
| Carbon black [3] | 56.60 | 56.60 | 56.60 | 56.60 | 56.60 | 56.60 |
| Hydrophobically modified | | | | | 0.50 | |
| alkali swellable acrylic | | | | | | |
| emulsion rheology | | | | | | |
| modifier [5] | | | | | | |
| Hydrophobically modified | | | | | | 0.50 |
| alkali swellable acrylic | | | | | | |
| emulsion rheology | | | | | | |
| modifier [6] | | | | | | |
| Alkali-swellable acrylic | 0.50 | | | | | |
| emulsion rheology | | | | | | |
| modifier [7] | | | | | | |
| Hydrophobically modified | | 0.50 | | | | |
| Ethoxylated Urethane | | | | | | |
| copolymer rheology | | | | | | |
| modifier [8] | | | | | | |
| Hydrophobically modified | | | 0.50 | | | |
| Ethoxylated Urethane | | | | | | |
| copolymer rheology | | | | | | |
| modifier [9] | | | | | | |
| Hydrophobically modified | | | | 0.50 | | |
| Ethoxylated Urethane | | | | | | |
| copolymer rheology | | | | | | |
| modifier [10] | | | | | | |
| Siloxane | 0.73 | 0.73 | 0.73 | 0.73 | 0.73 | 0.73 |
| Polyalkyleneoxide | | | | | | |
| Copolymer [11] | | | | | | |

[1] Exceval™ RS-1717, supplied by Kuraray.
[2] L3838 aqueous dispersion, supplied by Hauthaway as a 35% dispersion in water.
[3] Nerox® 3500, supplied by Orion Engineered Carbon.
[4] CARBODILITE® V-02-L2, supplied by Nisshinbo Chemical as a 40% solution in water.
[5] Solthix™ A-100, supplied by Lubrizol.
[6] Rheovis® HS 1212, supplied by BASF.
[7] Rheovis® AS 1130, supplied by BASF.
[8] Rheovis® PU 1191, supplied by BASF.
[9] Acrysol™ RM-8W, supplied by Dow Chemical.
[10] Optiflo® 3300, supplied by Byk.
[11] Silwet® L-7607 copolymer, supplied by Momentive.

TABLE 2A
Aqueous sealing composition comprising various
rheology modifiers and rheology measurements.

| | | | | Comparative | Comparative |
|---|---|---|---|---|---|
| Ingredients | Ex. 4 | Ex. 7 | Ex. 8 | Ex. 5 | Ex. 9 |
| Poly(vinyl alcohol-co-ethylene) | 4.60 | 4.60 | 4.60 | 4.60 | 4.60 |
| copolymer [1] | | | | | |
| Polyurethane aqueous | 2.72 | 2.72 | 2.72 | 2.72 | 2.72 |
| dispersion [2] | | | | | |
| Carbon black [3] | 10.05 | 10.05 | 10.05 | 10.05 | 10.05 |
| Polycarbodiimide | 0.17 | 0.17 | 0.17 | 0.17 | 0.17 |
| (Multifunctional | | | | | |
| polycarbodiimide [4] | | | | | |
| Hydrophobically modified alkali | | | | 0.09 | 0.10 |
| swellable acrylic emulsion | | | | | |
| rheology modifier [5] | | | | | |
| Hydrophobically modified alkali | | | | | |
| swellable acrylic emulsion | | | | | |
| rheology modifier [6] | | | | | |
| Alkali-swellable acrylic emulsion | | | | | |
| rheology modifier [7] | | | | | |
| Hydrophobically modified | | | | | |
| Ethoxylated Urethane copolymer | | | | | |
| rheology modifier [8] | | | | | |
| Hydrophobically modified | | | | | |
| Ethoxylated Urethane copolymer | | | | | |
| rheology modifier [9] | | | | | |
| Hydrophobically modified | 0.09 | 0.17 | 0.12 | | |
| Ethoxylated Urethane copolymer | | | | | |
| rheology modifier [10] | | | | | |
| Siloxane Polyalkyleneoxide | 0.13 | 0.13 | 0.13 | 0.13 | 0.16 |
| Copolymer [11] | | | | | |
| Ammonium Hydroxide to adjust | | | | | |
| pH to 6.5-8.5 | | | | | |
| Deionized water | Q.S. | Q.S. | Q.S. | Q.S. | Q.S. |
| H-B Rate Index | 0.86 | 0.82 | | 0.66 | |
| Thixotropy Index | 2.5 | 1.5 | | 1.4 | |

TABLE 2B
Sealing films formed by aqueous sealing compositions comprising
various rheology modifiers and coating quality measurements.

| | | | | Comparative | Comparative |
|---|---|---|---|---|---|
| Ingredients | Ex. 4F | Ex. 7F | Ex. 8F | Ex. 5F | Ex. 9F |
| Poly(vinyl alcohol-co-ethylene) | 25.90 | 25.78 | 25.86 | 25.90 | 25.84 |
| copolymer [1] | | | | | |
| Polyurethane aqueous | 16.27 | 16.2 | 16.24 | 16.27 | 16.23 |
| dispersion [2] | | | | | |
| Carbon black [3] | 56.60 | 56.35 | 56.50 | 56.60 | 56.47 |
| Hydrophobically modified alkali | | | | 0.50 | 0.56 |
| swellable acrylic emulsion | | | | | |
| rheology modifier [5] | | | | | |
| Hydrophobically modified alkali | | | | | |
| swellable acrylic emulsion | | | | | |
| rheology modifier [6] | | | | | |
| Alkali-swellable acrylic emulsion | | | | | |
| rheology modifier [7] | | | | | |
| Hydrophobically modified | | | | | |
| Ethoxylated Urethane copolymer | | | | | |
| rheology modifier [8] | | | | | |
| Hydrophobically modified | | | | | |
| Ethoxylated Urethane copolymer | | | | | |
| rheology modifier [9] | | | | | |
| Hydrophobically modified | 0.50 | 0.94 | 0.67 | | |
| Ethoxylated Urethane copolymer | | | | | |
| rheology modifier [10] | | | | | |
| Siloxane Polyalkyleneoxide | 0.73 | 0.73 | 0.73 | 0.73 | 0.90 |
| Copolymer [11] | | | | | |
| Cloudy Spot Mura (CSM) | 0.44 | 0.25 | 0.50 | 1.50 | 2.00 |
| Dewetting | 0 | 0 | 0 | 1 | 1 |
| Chatter | 0.5 | 0.5 | | 1 | |

[1] Exceval™ RS-1717, supplied by Kuraray.
[2] L3838 aqueous dispersion, supplied by Hauthaway as a 35% dispersion in water.
[3] Nerox® 3500, supplied by Orion Engineered Carbon.
[4] CARBODILITE® V-02-L2, supplied by Nisshinbo Chemical as a 40% solution in water.
[5] Solthix™ A-100, supplied by Lubrizol.
[6] Rheovis® HS 1212, supplied by BASF.
[7] Rheovis® AS 1130, supplied by BASF.
[8] Rheovis® PU 1191, supplied by BASF.
[9] Acrysol™ RM-8W, supplied by Dow Chemical.
[10] Optiflo® 3300, supplied by Byk.
[11] Silwet® L-7607 copolymer, supplied by Momentive.

Table 2B shows that aqueous sealing compositions that comprise HEUR rheology modifiers, such as Optiflo® 3300, provide improved coating quality of the corresponding sealing films in comparison to aqueous sealing compositions that comprise HASE rheology modifiers, such as Solthix™ A-1000. This can be demonstrated by the higher grading of the corresponding Cloudy Spot Mura (CSM), Dewetting, Chatter observed (Ex. 4, Ex. 7. and Ex. 8 versus Comparative Ex. 5 and Comparative Ex. 9). The rheology characteristics of the aqueous sealing compositions that comprise HEUR rheology modifiers are distinctly different from those of the aqueous sealing compositions that comprise HASE rheology modifiers. Specifically, the improved sealing films are formed from aqueous sealing composition that have (a) H-B Rate Index of 0.7 or higher, or from 0.7 to 1, or from 0.7 to 0.9, or from 0.7 to 2, (b) Viscosity Ratio 7 or lower, or from 1 to 7, or from 2 to 7, or from 0.5 to 7, and (c) Thixotropic Index 1.5 and higher, or between 1.5 and 3. Similarly, aqueous sealing composition comprising ASE rheology modifier (Ex. 1) shows similar rheology characteristics and provide sealing films having good coating quality. Furthermore, it was observed that the image resolution of display devices having sealing film formed by aqueous sealing composition comprising HEUR rheology modifier is better than the resolution of display devices having sealing film formed by aqueous sealing composition comprising HASE rheology modifier, when the resolution is measured at 50° C.

TABLE 2C
Aqueous sealing composition comprising various rheology modifiers and surfactants.

| Ingredients | Ex. 10 | Ex. 11 | Ex. 12 | Ex. 13 | Ex. 14 | Ex. 15 |
|---|---|---|---|---|---|---|
| Poly(vinyl alcohol-co-ethylene) | 8.74 | 8.74 | 8.74 | 8.71 | 8.70 | 8.71 |
| copolymer [1] | | | | | | |
| Polyurethane aqueous | 2.75 | 2.75 | 2.75 | 2.75 | 2.75 | 2.75 |
| dispersion [2] | | | | | | |
| Carbon black [3] | 6.06 | 6.06 | 6.06 | 6.06 | 6.06 | 6.06 |
| Polycarbodiimide | 0.18 | 0.18 | 0.18 | 0.18 | 0.18 | 0.18 |
| (Multifunctional | | | | | | |
| polycarbodiimide [4] | | | | | | |
| Hydrophobically modified | 0.13 | 0.16 | 0.13 | 0.16 | 0.13 | 0.13 |
| alkali swellable acrylic | | | | | | |
| emulsion rheology modifier [5] | | | | | | |
| Siloxane Polyalkyleneoxide | | | | | 0.13 | 0.09 |
| Copolymer [11] | | | | | | |
| Nonionic fluorosurfactant [12] | 0.01 | 0.01 | 0.05 | | | |
| Nonionic fluorosurfactant [13] | | | | 0.05 | | |
| Ammonium Hydroxide to | | | | | | |
| adjust pH to 6.5-8.5 | | | | | | |
| Deionized water | Q.S. | Q.S. | Q.S. | Q.S. | Q.S. | Q.S. |
| Ammonium Hydroxide to | | | | | | |
| adjust pH to 6.5-8.5 | | | | | | |
| Brookfield Viscosity | 6360 | 18240 | 5760 | 14520 | 11280 | 29760 |

TABLE 2D
Sealing films formed by aqueous sealing compositions comprising
various rheology modifiers and surfactants.

| Ingredients | Ex. 10F | Ex. 11F | Ex. 12F | Ex. 13F | Ex. 14F | Ex. 15F |
|---|---|---|---|---|---|---|
| Poly(vinyl alcohol-co-ethylene) | 48.92 | 48.82 | 48.81 | 48.63 | 48.47 | 48.61 |
| copolymer [1] | | | | | | |
| Polyurethane aqueous | 16.40 | 16.37 | 16.36 | 16.36 | 16.33 | 16.35 |
| dispersion [2] | | | | | | |
| Carbon black [3] | 33.92 | 33.85 | 33.84 | 33.83 | 33.76 | 33.82 |
| Hydrophobically modified | 0.71 | 0.91 | 0.71 | 0.71 | 0.71 | 0.71 |
| alkali swellable acrylic | | | | | | |
| emulsion rheology modifier [5] | | | | | | |
| Siloxane Polyalkyleneoxide | | | | | 0.72 | 0.50 |
| Copolymer [11] | | | | | | |
| Nonionic fluorosurfactant [12] | 0.06 | 0.06 | 0.28 | 0.28 | | |
| Brookfield Viscosity | 6360 | 18240 | 5760 | 14520 | 11280 | 29760 |

[1] Exceval™ RS-1717, supplied by Kuraray.
[2] L3838 aqueous dispersion, supplied by Hauthaway as a 35% dispersion in water.
[3] Nerox® 3500, supplied by Orion Engineered Carbon.
[4] CARBODILITE® V-02-L2, supplied by Nisshinbo Chemical as a 40% solution in water.
[5] Solthix™ A-100, supplied by Lubrizol.
[6] Rheovis® HS 1212, supplied by BASF.
[7] Rheovis® AS 1130, supplied by BASF.
[8] Rheovis® PU 1191, supplied by BASF.
[9] Acrysol™ RM-8W, supplied by Dow Chemical.
[10] Optiflo® 3300, supplied by Byk.
[11] Silwet® L-7607 copolymer, supplied by Momentive.
[12] Capstone™ FS-31, supplied by The Chemours Company.
[13] Capstone™ FS-3100, supplied by The Chemours Company.

Tables 2C and 2D disclose compositions comprising a rheology modifier (Solthix™ A-100) and various different surfactants, such as siloxane and fluorosurfactants. In the case of siloxane-based surfactants, it was observed that changes in the surfactant content of the formulation result in significant change in the viscosity of the aqueous sealing composition (see Ex. 12 versus Ex. 13). On the contrary, the viscosity of aqueous compositions comprising fluorosurfactants varies much less with change in the surfactant content (see Ex. 10 versus Ex. 12). This phenomenon is not trivial, because the surfactant enables the adjustment of the surface energy of the aqueous sealing composition on the microcell layer, which affects the coating quality of the resulting sealing film. Thus, it is viable to tune the aqueous sealing compositions using different surfactant content to achieve good coating quality for different microcell layers, improving wettability and minimizing coating defects. Various surfactants interact differently with the rheology modifier of the aqueous composition. When there is a strong interaction between the surfactant and the rheology modifier, as observed when siloxane surfactant are used, small changes to surfactant content significantly change the coatability and rheology profile making it more sensitive to the operational formulation window. That is, if the surfactant strongly interacts with the rheology modifier, it becomes not viable to select a high content of surfactant and effectively control surface energy of the aqueous sealing composition and wettability. The inventors of the present invention surprisingly found that the aqueous sealing compositions comprising fluorosurfactants showed less variation in their viscosity with varying surfactant content. Thus, the use of fluorosurfactants enable an easier optimization of the rheology profile and the optimal coating quality.

Table 3 includes surface energy data for the various Polymer 1 species, which is water soluble poly(vinyl alcohol) homopolymer or poly(vinyl alcohol-co-ethylene) copolymer, and Polymer 2 species, which is polyurethane. It also includes evaluation of the barrier properties of various layers and calculated interfacial of the various polymer combinations. The method for the preparation of the corresponding polymer layers that were used for barrier property evaluation is described in I above. The determination of surface energy (according to the method described in E above) was performed by first preparing and conditioning a sealing film from the corresponding aqueous compositions comprising only one polymer. The interfacial tension for each polymer combination was calculated from surface energy data and the calculation method described in H above.

TABLE 3
Barrier Property of Sealing Films.

| | | | Polymer 1 | | | | |
|---|---|---|---|---|---|---|---|
| | | | | Degree of | % | | |
| | | | Polarity | Hydrolysis | Ethylene | | |
| | Polymer 1 | Polymer 2 | (mN/m) | % | Content | | |
| Comparative | RS1717 | AM8100 | 13.3 | 93 | 8 | | |
| Ex. 14 | | | | | | | |
| Comparative | RS1717 | Dispercoll U 58 | 13.3 | 93 | 8 | | |
| Ex. 15 | | | | | | | |
| Comparative | RS1717 | Dispercoll 2643 U XP | 13.3 | 93 | 8 | | |
| Ex. 16 | | | | | | | |
| Comparative | RS1717 | WS-5000 | 13.3 | 93 | 8 | | |
| Ex. 17 | | | | | | | |
| Comparative | RS1717 | Dispercoll U 56 | 13.3 | 93 | 8 | | |
| Ex. 18 | | | | | | | |
| Comparative | RS1717 | Witcobond 386-03 | 13.3 | 93 | 8 | | |
| Ex. 19 | | | | | | | |
| Comparative | RS1717 | BPI-UD-104 | 13.3 | 93 | 8 | | |
| Ex. 20 | | | | | | | |
| Comparative | RS1717 | Witcobond 737 | 13.3 | 93 | 8 | | |
| Ex. 21 | | | | | | | |
| Comparative | RS2817SB | Witcobond 386-03 | 27.8 | 96.5 | 10 | | |
| Ex. 22 | | | | | | | |
| Comparative | RS1713 | Witcobond 737 | 16.9 | 93 | 8 | | |
| Ex. 23 | | | | | | | |
| Comparative | RS1713 | Witcobond 386-03 | 16.9 | 93 | 8 | | |
| Ex. 24 | | | | | | | |
| Comparative | OKS1009 | Witcobond 737 | 11.5 | >99 | 0 | | |
| Ex. 25 | | | | | | | |
| Comparative | RS1717 | Witcobond A-100 | 13.3 | 93 | 8 | | |
| Ex. 26 | | | | | | | |
| Ex. 27 | RS1717 | HD-2503 | 13.3 | 93 | 8 | | |
| Ex. 28 | RS1717 | HD-2125 | 13.3 | 93 | 8 | | |
| Ex. 29 | RS1717 | L3838 | 13.3 | 93 | 8 | | |
| Ex. 30 | RS1717 | PU677 | 13.3 | 93 | 8 | | |
| Ex. 31 | RS1717 | Takelac WPB341 | 13.3 | 93 | 8 | | |
| Ex. 32 | RS1717 | L-2897 | 13.3 | 93 | 8 | | |
| Ex. 33 | RS1717 | Dispercoll 2815U XP | 13.3 | 93 | 8 | | |
| Ex. 34 | RS2817SB | Dispercoll U 58 | 27.8 | 96.5 | 10 | | |
| Ex. 35 | RS2817SB | Dispercoll U 56 | 27.8 | 96.5 | 10 | | |
| Ex. 36 | Z410 | HD-2125 | 17.5 | 98 | 0 | | |
| Ex. 37 | OKS1109 | HD-2125 | 18.3 | >99 | 0 | | |
| Ex. 38 | OKS1009 | HD-2125 | 11.5 | >99 | 0 | | |
| Ex. 39 | RS1113 | HD-2125 | 22.9 | 98.5 | 8 | | |
| | | | Polymer 2 | | | | |
| | | | Dispersive | Polar | | | |
| | | | Component | Component | | | |
| | | | of the | of | Total | PVA-PUD | |
| | | | Surface | Surface | Surface | interfacial | |
| | | | Energy | Energy | Energy | tension | PASS/ |
| | Polymer 1 | Polymer 2 | (mN/m) | (mN/m) | (mN/m) | (mN/m) | FAIL |
| Comparative | RS1717 | AM8100 | 33 | 1 | 34 | 7.2 | FAIL |
| Ex. 14 | | | | | | | |
| Comparative | RS1717 | Dispercoll | 47 | 32.2 | 79 | 4.3 | FAIL |
| Ex. 15 | | U 58 | | | | | |
| Comparative | RS1717 | Dispercoll | 33 | 3.4 | 37 | 3.4 | FAIL |
| Ex. 16 | | 2643 U | | | | | |
| | | XP | | | | | |
| Comparative | RS1717 | WS-5000 | 45 | 3.5 | 48 | 3.4 | FAIL |
| Ex. 17 | | | | | | | |
| Comparative | RS1717 | Dispercoll | 45 | 28.6 | 74 | 3.2 | FAIL |
| Ex. 18 | | U 56 | | | | | |
| Comparative | RS1717 | Witcobond | 39 | 4.3 | 43 | 2.5 | FAIL |
| Ex. 19 | | 386-03 | | | | | |
| Comparative | RS1717 | BPI-UD- | 38 | 5 | 43 | 2 | FAIL |
| Ex. 20 | | 104 | | | | | |
| Comparative | RS1717 | Witcobond | 42 | 5.2 | 47 | 2 | FAIL |
| Ex. 21 | | 737 | | | | | |
| Comparative | RS2817SB | Witcobond | 39 | 4.3 | 43 | 10.5 | FAIL |
| Ex. 22 | | 386-03 | | | | | |
| Comparative | RS1713 | Witcobond | 42 | 5.2 | 47 | 4.2 | FAIL |
| Ex. 23 | | 737 | | | | | |
| Comparative | RS1713 | Witcobond | 39 | 4.3 | 43 | 3.4 | FAIL |
| Ex. 24 | | 386-03 | | | | | |
| Comparative | OKS1009 | Witcobond | 42 | 5.2 | 47 | 2.9 | FAIL |
| Ex. 25 | | 737 | | | | | |
| Comparative | RS1717 | Witcobond | 47 | 4.3 | 52 | 3 | FAIL |
| Ex. 26 | | A-100 | | | | | |
| Ex. 27 | RS1717 | HD-2503 | 48 | 11.5 | 59 | 0.6 | PASS |
| Ex. 28 | RS1717 | HD-2125 | 48 | 14.2 | 62 | 0.6 | PASS |
| Ex. 29 | RS1717 | L3838 | 47 | 11.4 | 58 | 0.5 | PASS |
| Ex. 30 | RS1717 | PU677 | 44 | 16.8 | 61 | 0.4 | PASS |
| Ex. 31 | RS1717 | Takelac | 45 | 14.2 | 59 | 0.3 | PASS |
| | | WPB341 | | | | | |
| Ex. 32 | RS1717 | L-2897 | 48 | 13.3 | 61 | 0.2 | PASS |
| Ex. 33 | RS1717 | Dispercoll | 37 | 14.8 | 52 | 0 | PASS |
| | | 2815U XP | | | | | |
| Ex. 34 | RS2817SB | Dispercoll | 47 | 32.2 | 79 | 0.1 | PASS |
| | | U 58 | | | | | |
| Ex. 35 | RS2817SB | Dispercoll | 45 | 28.6 | 74 | 0 | PASS |
| | | U 56 | | | | | |
| Ex. 36 | Z410 | HD-2125 | 48 | 14.2 | 62 | 0.4 | PASS |
| Ex. 37 | OKS1109 | HD-2125 | 48 | 14.2 | 62 | 0.8 | PASS |
| Ex. 38 | OKS1009 | HD-2125 | 48 | 14.2 | 62 | 0.4 | PASS |
| Ex. 39 | RS1113 | HD-2125 | 48 | 14.2 | 62 | 1.8 | PASS |

TABLE 4
Commercial materials used in the Examples of Table 3.

| | Polymer | Chemical Name | Commercial Name | Supplier |
|---|---|---|---|---|
| RS1717 | Polymer 1 | Poly(vinyl alcohol-co- | Exceval ™ RS-1717 | Kuraray |
| | | ethylene) copolymer | | |
| RS2817SB | Polymer 1 | Poly(vinyl alcohol-co- | Exceval ™ RS-2817SB | Kuraray |
| | | ethylene) copolymer | | |
| RS1713 | Polymer 1 | Poly(vinyl alcohol-co- | Exceval ™ RS-1713 | Kuraray |
| | | ethylene) copolymer | | |
| OKS1009 | Polymer 1 | Poly(vinyl alcohol) | OKS-1009 | Soarus |
| | | homopolymer | | |
| OKS1110 | Polymer 1 | Poly(vinyl alcohol) | OKS-1109 | Soarus |
| | | homopolymer | | |
| Z410 | Polymer 1 | Poly(vinyl alcohol) | GOHSENX ™ Z-410 | Soarus |
| | | homopolymer | | |
| RS1113 | Polymer 1 | Poly(vinyl alcohol-co- | Exceval ™ RS-1113 | Kuraray |
| | | ethylene) copolymer | | |
| AM8100 | Polymer 2 | Polyurethane aqueous | Aptalon ™ M8100 | Lubrizol |
| | | dispersion (polyamide) | | |
| Dispercoll U58 | Polymer 2 | Polyurethane aqueous | Dispercoll ® U58 | Covestro |
| | | dispersion | | |
| Dispercoll 2643 U | Polymer 2 | Polyurethane aqueous | Dispercoll ® U XP | Covestro |
| XP | | dispersion | 2643 | |
| WS-5000 | Polymer 2 | Polyurethane aqueous | Takelac ™ WS-5000 | Mitsui |
| | | dispersion | | Chemicals |
| Witcobond 386-03 | Polymer 2 | Polyurethane aqueous | Witcobond ® 386-03 | Chemtura |
| | | dispersion (polyester) | | Corp. |
| BPI-UD-104 | Polymer 2 | Polyurethane aqueous | Bondathane ™ UD 104 | Bond |
| | | dispersion (polyester) | (BPI-ID 104) | Polymers |
| | | | | International |
| Witcobond 737 | Polymer 2 | Polyurethane aqueous | Witcobond ® 737 | Chemtura |
| | | dispersion (polyester) | | Corp. |
| Witcobond A-100 | Polymer 2 | Polyurethane aqueous | Witcobond ® A-100 | Chemtura |
| | | dispersion | | Corp. |
| HD-2503 | Polymer 2 | Polyurethane aqueous | Hauthane HD-2503 | Hauthane & |
| | | dispersion | | Sons Corp. |
| HD-2125 | Polymer 2 | Polyurethane aqueous | Hauthane HD-2125 | Hauthane & |
| | | dispersion (polyester, | | Sons Corp. |
| | | polycarbonate) | | |
| L3838 | Polymer 2 | Polyurethane aqueous | Hauthane L3838 | Hauthane & |
| | | dispersion (polyester) | | Sons Corp. |
| PU677 | Polymer 2 | Polyurethane aqueous | Relca ® PU-677 | Stahl |
| | | dispersion | | |
| Takelac WPB341 | Polymer 2 | Polyurethane aqueous | Takelac ™ WBP-341 | Mitsui |
| | | dispersion (polyester) | | Chemicals |
| L-2897 | Polymer 2 | Polyurethane aqueous | Hauthane L2897 | Hauthane & |
| | | dispersion (polyester) | | Sons Corp. |
| Dispercoll 2815U | Polymer 2 | Polyurethane aqueous | Dispercoll ® U 2815 | Covestro |
| XP | | dispersion (polyester) | XP | |
| Dispercoll U 56 | Polymer 2 | Polyurethane aqueous | Dispercoll ® U56 | Covestro |
| | | dispersion (polyester) | | |

The data of interfacial tension of Polymer 1 and Polymer 2 of Table 3 show that the sealing films that comprise (a) poly(vinyl alcohol) polymer or poly(vinyl alcohol-co-ethylene) copolymer having a degree of hydrolysis of from 90% to 99.5% and ethylene content of less than 10%, and (b) a polyurethane in an aqueous carrier, wherein the interfacial tension between the two polymers (a) and (b) is less than 2 mN/m, form sealing films that have good barrier properties for a non-polar fluid.

The data of Table 3 also show that the sealing films made from aqueous sealing compositions that comprise (a) poly(vinyl alcohol) polymer or poly(vinyl alcohol-co-ethylene) copolymer having a degree of hydrolysis of from 90% to 99.5% and ethylene content of less than 10%, and (b) a polyurethane in an aqueous carrier, wherein the polar component of the surface energy of the polyurethane is between 10 and 25 mN/m, form sealing films that have good barrier properties for a non-polar fluid.

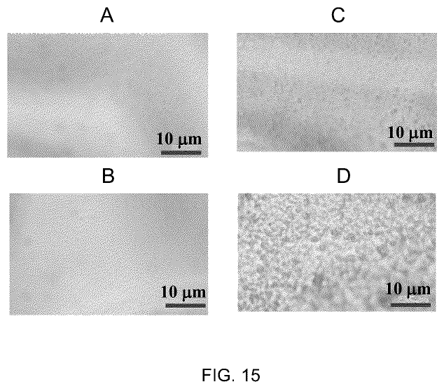

Microscopic evaluation of polymer films prepared by four aqueous sealing compositions prepared by the method described in B1 above showed that there is a correlation between uniformity of the film and the interfacial tension between the two polymers. Table 5 and the microscopic images of FIG. 15 show that lower interfacial tension provides more uniform polymer films. The improved compatibility achieved by the combination of the polymers having smaller interfacial tension, may explain the improved barrier properties of the corresponding layer.

TABLE 5
Polymer films comprising a combination of poly(vinyl alcohol-co-ethylene)
copolymer and polyurethane having different interfacial tensions.

| | | PVA-PUD | Microscopic |
|---|---|---|---|
| | | interfacial | Image |
| Polymer 1 | Polymer 2 | tension (mN/m) | FIG. 15 |
| Poly(vinyl alcohol-co-ethylene) | Polyurethane aqueous | 0.03 | A |
| copolymer; Exceval ™ RS- | dispersion | | |
| 1717, supplied by Kuraray | Witcobond ® 373-05, | | |
| | supplied by Chemtura | | |
| Poly(vinyl alcohol-co-ethylene) | Polyurethane aqueous | 1.95 | B |
| copolymer; Exceval ™ RS- | dispersion (polyester) | | |
| 1717, supplied by Kuraray | Dispercoll ® 2815 XP, | | |
| | supplied by Covestro | | |
| Poly(vinyl alcohol-co-ethylene) | Polyurethane aqueous | 3.42 | C |
| copolymer; Exceval ™ RS- | dispersion (polyester) | | |
| 1717, supplied by Kuraray | Dispercoll ® 2643 U XP, | | |
| | supplied by Covestro | | |
| Poly(vinyl alcohol-co-ethylene) | Polyurethane aqueous | 4.42 | D |
| copolymer; Exceval ™ RS- | dispersion | | |
| 1717, supplied by Kuraray | Witcobond ® 361-72, | | |
| | supplied by Chemtura | | |

Furthermore, it was observed during the study, that aqueous sealing compositions comprising more than 70 weight % of poly(vinyl alcohol) homopolymer or poly(vinyl alcohol-co-ethylene) copolymer by weight of the aqueous sealing composition excluding water form sealing films that absorb significant amount of moisture from the environment. This high moisture absorption negatively affects the electro-optic performance of the display.

What is claimed is:

1. A sealing film comprising:
from 15 to 60 weight % of a water soluble poly(vinyl alcohol) homopolymer or poly(vinyl alcohol-co-ethylene) copolymer by weight of the sealing film, wherein the poly(vinyl alcohol) homopolymer has a degree of hydrolysis of from 90% to 99.5%, and wherein the poly(vinyl alcohol-co-ethylene) copolymer has a degree of hydrolysis of from 90% to 99.5% and ethylene content of less than 10%;
from 7 to 29 weight % of a polyurethane by weight of the sealing film;
from 0.05 to 10 weight % of a rheology modifier by weight of the sealing film, wherein the rheology modifier is selected from the group consisting of Hydrophobically Modified Ethoxylated Urethane and Alkali Swellable Emulsion polymer.

2. The sealing film of claim 1 further comprising from 0.01 to 5 weight % of a surfactant by weight of the sealing film.

3. The sealing film of claim 2, wherein the surfactant is a fluorosurfactant.

4. The sealing film of claim 1, further comprising from 5 to 70 weight % of carbon black by weight of the sealing film.

5. The sealing film of claim 1, further comprising from 4.5 to 25 wt % of a water soluble ether by weight of the sealing film, the water soluble ether having molecular weight of from 75 to 5,000 Dalton, and optionally comprising a hydroxyl group.

6. The sealing film of claim 1, wherein the total surface energy of the sealing film is lower than 60 mN/m.

7. The sealing film of claim 1, wherein the interfacial tension between the water soluble poly(vinyl alcohol) polymer or poly(vinyl alcohol-co-ethylene) copolymer and the polyurethane being less than 2 mN/m.

8. An electro-optic device comprising
a conductive layer;
a microcell layer comprising a plurality of microcells, each microcell including an opening, each microcell comprising an electrophoretic medium, the electrophoretic medium comprising charged particles in a non-polar carrier;
a sealing film according to claim 1, the sealing film spanning the opening of each microcell;
an adhesive layer; and
an electrode layer.

9. An aqueous sealing composition comprising:
from 15 to 60 weight % of a water soluble poly(vinyl alcohol) homopolymer or poly(vinyl alcohol-co-ethylene) copolymer by weight of the aqueous sealing composition excluding water, wherein the poly(vinyl alcohol) homopolymer has a degree of hydrolysis of from 90% to 99.5%, and wherein the poly(vinyl alcohol-co-ethylene) copolymer has a degree of hydrolysis of from 90% to 99.5% and ethylene content of less than 10%;
from 7 to 29 weight % of a polyurethane by weight of the aqueous sealing composition excluding water;
from 0.05 to 10 weight % of a rheology modifier by weight of the aqueous sealing composition excluding water, wherein the rheology modifier is selected from the group consisting of Hydrophobically Modified Ethoxylated Urethane and Hydrophobically Modified Alkali Swellable Emulsion polymer;
from 0.01 to 5 weight % of a surfactant by weight of the aqueous sealing composition excluding water; and
from 20 to 95 weight % water by weight of the aqueous sealing composition.

10. The aqueous sealing composition of claim 9, wherein the surfactant is a fluorosurfactant.

11. The aqueous sealing composition of claim 9, further comprising from 5 to 70 weight % of carbon black by weight of aqueous sealing composition excluding water.

12. The aqueous sealing composition of claim 9, further comprising from 1.0 to 40 weight % of a water soluble ether by weight of the aqueous sealing composition excluding water, the water soluble ether having molecular weight of from 75 to 5,000 Dalton, and optionally comprising a hydroxyl group.

13. The aqueous sealing composition of claim 9, further comprising from 0.1 to 8 weight % of a polyurethane crosslinker by weight of the aqueous sealing composition excluding water.

14. The aqueous sealing composition of claim 13, wherein the polyurethane crosslinker is a polyisocyanate, a multifunctional polycarbodiimide, a multifunctional aziridine, a silane coupling agent, a boron/titanium/zirconium-based crosslinker, or a melamine formaldehyde.

15. The aqueous sealing composition of claim 9, wherein the Viscosity Ratio of the aqueous sealing composition at shear rate of 10⁻⁴ l/s divided by the viscosity of the aqueous sealing composition at shear rate of 10² l/s is 7 or lower.

16. The aqueous sealing composition of claim 9, wherein the Viscosity Ratio of the aqueous sealing composition at shear rate of 10⁻⁴ l/s divided by the viscosity of the aqueous sealing composition at shear rate of 10² l/s is from 1 to 7.

17. The aqueous sealing composition of claim 9 having an H-B Rate Index of 0.7 or higher.

18. The aqueous sealing composition of claim 9 having an H-B Rate Index of from 0.7 to 1.

19. The aqueous sealing composition of claim 9 having a thixotropic index 1.5 or higher.

20. The aqueous sealing composition of claim 9 having a thixotropic index of from 1.5 to 3.
